(19) United States
(12) Patent Application Publication
(10) Pub. No.: US 2026/0292556 A1
(43) Pub. Date: Sep. 24, 2026

(54) METHOD AND DEVICE FOR PROCESSING INACTIVE CHANNEL INFORMATION IN WIRELESS LAN SYSTEM

(71) Applicant: LG ELECTRONICS INC., Seoul (KR)

(72) Inventors: Dongguk LIM, Seoul (KR); Jinyoung CHUN, Seoul (KR); Jinsoo CHOI, Seoul (KR); Eunsung PARK, Seoul (KR)

(73) Assignee: LG ELECTRONICS INC., Seoul (KR)

(21) Appl. No.: 19/477,574

(22) PCT Filed: Apr. 15, 2024
(86) PCT No.: PCT/KR2024/005033

§ 371 Date: Oct. 22, 2025

(30) Foreign Application Priority Data
May 11, 2023 (KR) 10-2023-0061177

(51) Int. Cl. H04W 24/08; H04W 84/12

(52) U.S. Cl. CPC H04W 24/08; H04W 84/12

(57) ABSTRACT

The present disclosure relates to processing inactive channel information in a wireless local area network (LAN) system. A method performed by a station (STA) in a wireless LAN system, according to an embodiment of the present disclosure, comprises the steps of: receiving measurement instructions for inactive channel measurement for a relay channel between a relay STA and the STA; receiving, from the relay STA, a signal for channel measurement of the relay channel; performing the inactive channel measurement for the relay channel on the basis of the measurement instructions and the signal for channel measurement; and transmitting inactive channel information including a result of the inactive channel measurement.

### CROSS-REFERENCE TO RELATED APPLICATIONS

This application is the National Stage filing under 35 U.S.C. 371 of International Application No. PCT/KR2024/005033, filed on Apr. 15, 2024, which claims the benefit of earlier filing date and right of priority to Korean Application No. 10-2023-0061177, filed on May 11, 2023, the contents of which are all hereby incorporated by reference herein in their entireties.

### TECHNICAL FIELD

The present disclosure is related to processing disabled channel information in a wireless local area network (WLAN) system.

### BACKGROUND

Next-generation Wi-Fi (e.g., IEEE 802.11be and/or later) aims to support ultra-high reliability in signaling to STAs, and various technologies are being considered to support high throughput, low latency, and extended range. For example, to extend reliable transmission and/or coverage/communication range for various STAs (e.g., IoT devices), a relay operation may be considered, in which an AP transmits a signal to one or more non-AP STAs or receives a signal from one or more non-AP STAs via an intermediate relay device. A technology for efficiently performing such relay operation is required.

### SUMMARY

An aspect of the present disclosure is to provide method and apparatus for processing disabled channel information in a WLAN system.

According to an embodiment of the present disclosure, a method performed by a station (STA) in a wireless local area network (LAN) system comprises: receiving a measurement indication instructing a disabled channel measurement for a relay channel between a relay STA and the STA; receiving, from the relay STA, a signal for channel measurement of the relay channel; performing the disabled channel measurement for the relay channel based on the measurement indication and the signal for the channel measurement; and transmitting disabled channel information comprising a result of the disabled channel measurement.

According to an embodiment of the present disclosure, a method performed by an access point (AP) in a wireless local area network (LAN) system comprises: transmitting a measurement indication instructing a disabled channel measurement for a relay channel between a relay station (STA) and a STA; receiving disabled channel information comprising a result of the disabled channel measurement; allocating resources for data communication between the relay STA and the STA on the relay channel based on the disabled channel information; and transmitting information for the allocated resources.

In various embodiments, apparatuses implementing the above methods are provided.

The present disclosure may have various advantageous effects.

For example, during relay transmission, the AP may allocate a resource unit (RU) suitable for the relay transmission by using information for available channels and/or disabled channels between the relay STA and the non-AP STA. The relay transmission may then be performed based on the allocated RU, thereby improving the efficiency and throughput of the relay transmission.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 illustrates an example of a transmitting apparatus and/or receiving apparatus of the present disclosure.

FIG. 2 is a conceptual view illustrating the structure of a wireless local area network (WLAN).

FIG. 3 illustrates a general link setup process.

FIG. 4 illustrates an example of a multi-link (ML).

FIG. 5 illustrates a modified example of a transmitting device and/or a receiving device of the present disclosure.

FIG. 6 illustrates an example of a physical protocol data unit or physical layer (PHY) protocol data unit (PPDU) transmitted/received by an STA of the present disclosure.

FIG. 7 illustrates the layout of resource units (Rus) used for a 20 MHz PPDU.

FIG. 8 illustrates the layout of resource units (Rus) used for 40 MHz PPDU.

FIG. 9 illustrates the layout of resource units (Rus) used for an 80 MHz PPDU.

FIG. 10 illustrates an operation related to UL-MU.

FIG. 11 illustrates an example of channels used/supported/defined within the 2.4 GHz band.

FIG. 12 illustrates an example of channels used/supported/defined within the 5 GHz band.

FIG. 13 illustrates an example of channels used, supported, and defined within the 6 GHz band.

FIG. 14 illustrates a trigger frame format.

FIGS. 15a and 15b show Common Info field format.

FIGS. 16a and 16b show User Info field format.

FIG. 17 illustrates an example in which preamble puncturing is applied.

FIG. 18 illustrates an example of a channel sounding procedure.

FIG. 19 illustrates an example of relay transmission/operation.

FIG. 20 illustrates an example of a method performed by a STA for processing disabled channel information according to an embodiment of the present disclosure.

FIG. 21 illustrates an example of a method performed by an AP for processing disabled channel information according to an embodiment of the present disclosure.

FIG. 22 illustrates a first example of a procedure for measuring available subchannels on a relay channel according to an embodiment of the present disclosure.

FIG. 23 illustrates a second example of a procedure for measuring available subchannels on a relay channel according to an embodiment of the present disclosure.

FIG. 24 illustrates a third example of a procedure for measuring available subchannels in a relay channel according to an embodiment of the present disclosure.

### DETAILED DESCRIPTION

In the present disclosure, “A or B” may mean “only A”, “only B” or “both A and B”. In other words, in the present disclosure, “A or B” may be interpreted as “A and/or B”. For example, in the present disclosure, “A, B, or C” may mean “only A”, “only B”, “only C”, or “any combination of A, B, C”.

A slash (/) or comma used in the present disclosure may mean “and/or”. For example, “A/B” may mean “A and/or B”. Accordingly, “A/B” may mean “only A”, “only B”, or “both A and B”. For example, “A, B, C” may mean “A, B, or C”.

In the present disclosure, “at least one of A and B” may mean “only A”, “only B”, or “both A and B”. In addition, in the present disclosure, the expression “at least one of A or B” or “at least one of A and/or B” may be interpreted as “at least one of A and B”.

In addition, a parenthesis used in the present disclosure may mean “for example”. Specifically, when indicated as “control information (UHR-signal field)”, it may mean that “UHR-signal field” is proposed as an example of the “control information”. In other words, the “control information” of the present disclosure is not limited to “UHR-signal field”, and “UHR-signal field” may be proposed as an example of the “control information”. In addition, when indicated as “control information (i.e., UHR-signal field)”, it may also mean that “UHR-signal field” is proposed as an example of the “control information”.

Also, “a/an” as used in this disclosure can mean “at least one” or “one or more.” Also, a term ending with “(s)” can mean “at least one” or “one or more.”

Also, the expressions “based on” or “on the basis of” or “according to” as used in this disclosure mean “based at least in part on,” and do not mean “based sonly on.”

Technical features described individually in one figure in the present disclosure may be individually implemented, or may be simultaneously implemented.

The following example of the present disclosure may be applied to various wireless communication systems. For example, the following example of the present disclosure may be applied to a wireless local area network (WLAN) system. For example, the present disclosure may be applied to the IEEE 802.11a/g/n/ac/ax/be/bn standard. In addition, an example of the present disclosure can also be applied to a next-generation wireless LAN standard that enhances the Ultra High Reliability (UHR) standard or IEEE 802.11bn. In addition, the example of the present disclosure may also be applied to a new WLAN standard enhanced from the EHT standard or the IEEE 802.11be standard. In addition, the example of the present disclosure may be applied to a mobile communication system. For example, it may be applied to a mobile communication system based on long term evolution (LTE) depending on a 3rd generation partnership project (3GPP) standard and based on evolution of the LTE. In addition, the example of the present disclosure may be applied to a communication system of a 5G NR standard based on the 3GPP standard.

Hereinafter, in order to describe a technical feature of the present disclosure, a technical feature applicable to the present disclosure will be described.

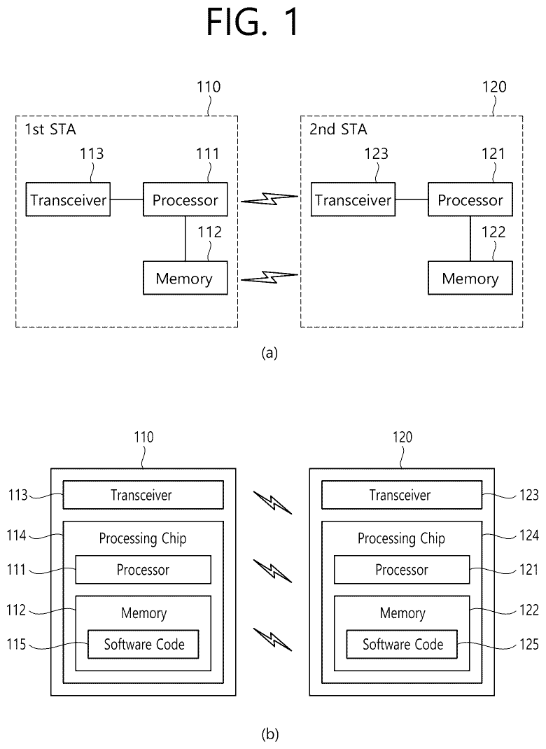

FIG. 1 illustrates an example of a transmitting apparatus and/or receiving apparatus of the present disclosure.

In the example of FIG. 1, various technical features described below may be performed. FIG. 1 relates to at least one station (STA). For example, STAs 110 and 120 of the present disclosure may also be called in various terms such as a mobile terminal, a wireless device, a wireless transmit/receive unit (WTRU), a user equipment (UE), a mobile station (MS), a mobile subscriber unit, or simply a user. The STAs 110 and 120 of the present disclosure may also be called in various terms such as a network, a base station, a node-B, an access point (AP), a repeater, a router, a relay, or the like. The STAs 110 and 120 of the present disclosure may also be referred to as various names such as a receiving apparatus, a transmitting apparatus, a receiving STA, a transmitting STA, a receiving device, a transmitting device, or the like.

For example, the STAs 110 and 120 may serve as an AP or a non-AP. That is, the STAs 110 and 120 of the present disclosure may serve as the AP and/or the non-AP. In the present disclosure, the AP may be indicated as an AP STA.

The STAs 110 and 120 of the present disclosure may support various communication standards together in addition to the IEEE 802.11 standard. For example, a communication standard (e.g., LTE, LTE-A, 5G NR standard) or the like based on the 3GPP standard may be supported. In addition, the STA of the present disclosure may be implemented as various devices such as a mobile phone, a vehicle, a personal computer, or the like. In addition, the STA of the present disclosure may support communication for various communication services such as voice calls, video calls, data communication, and self-driving (autonomous-driving), or the like.

The STAs 110 and 120 of the present disclosure may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., TX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., TX signal) to be transmitted through the transceiver.

For example, an operation of a device indicated as an AP in the disclosure described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the disclosure described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the disclosure described below, a device called a (transmitting/receiving) STA, a first STA, a second STA, an STA1, an STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in include: advance May 1) an operation of determining/obtaining/configuring/computing/decoding/encoding bit information of a sub-field (SIG, STF, LTF, I included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of the present disclosure will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a receiving STA, a transmitting STA, a receiving device, a transmitting device, a receiving apparatus, and/or a transmitting apparatus, which are described below, may imply the STAs 110 and 120 Illustrated In the sub-figure (a)/(b) of FIG. 1, or may imply the processing chips 114 and 124 illustrated in the sub-figure (b) of FIG. 1. That is, a technical feature of the present disclosure may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the receiving STA receives the control signal may be understood as a technical feature in which the control signal is received by means of the transceivers 113 and 123 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In the present disclosure, an uplink may imply a link for communication from a non-AP STA to an AP STA, and an uplink PPDU/packet/signal or the like may be transmitted through the uplink. In addition, in the present disclosure, a downlink may imply a link for communication from the AP STA to the non-AP STA, and a downlink PPDU/packet/signal or the like may be transmitted through the downlink.

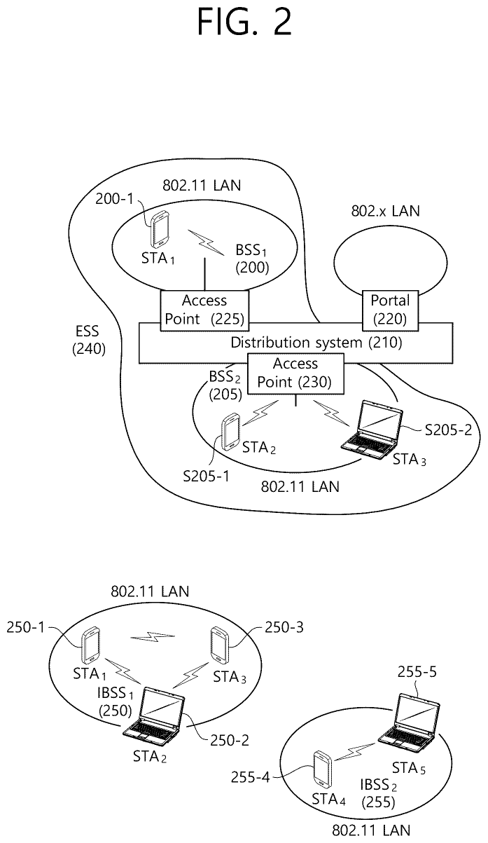

FIG. 2 is a conceptual view illustrating the structure of a wireless local area network (WLAN).

An upper part of FIG. 2 illustrates the structure of an infrastructure basic service set (BSS) of institute of electrical and electronic engineers (IEEE) 802.11.

Referring the upper part of FIG. 2, the wireless LAN system may include one or more infrastructure BSSs 200 and 205 (hereinafter, referred to as BSS). The BSSs 200 and 205 as a set of an AP and an STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (IEEE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

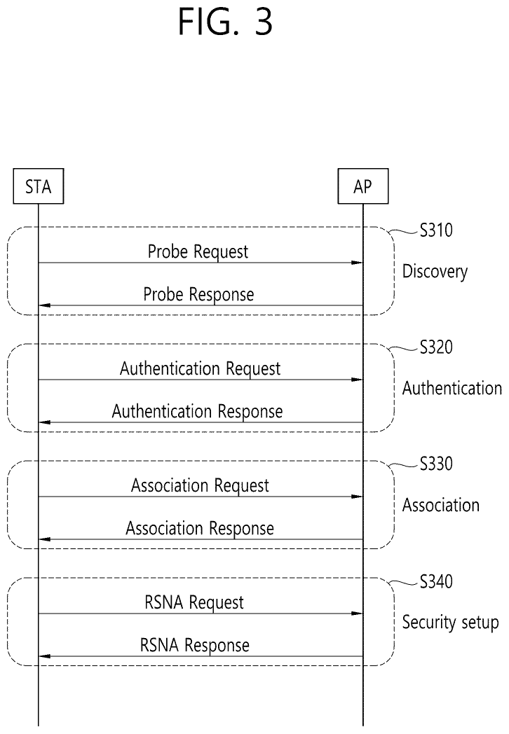

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information about a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information about an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information about various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information about various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

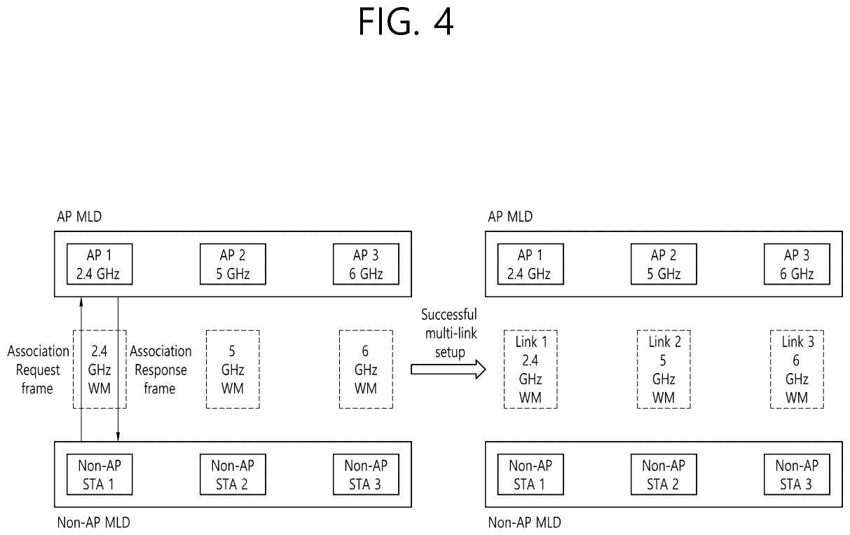

FIG. 4 illustrates an example of a multi-link (ML).

As illustrated in FIG. 4, multiple multi-link devices (MLDs) can perform communication via a remote link. The MLD can be classified into an AP MLD including multiple AP STAs and a non-AP MLD including multiple non-AP STAs. That is, the AP MLD can include affiliated APs (i.e., AP STAs), and the non-AP MLD can include affiliated STAs (i.e., non-AP STAs, or user-STAs).

The multi-link can include a first link and a second link, and different channels/subchannels/frequency resources can be allocated to the first and second links. The first and second multi-links can be identified through a link ID of 4 bits (or other n bits). The first and second links may be configured in the same 2.4 GHZ, 5 GHZ, or 6 GHz band. Alternatively, the first link and the second link may be configured in different bands.

The AP MLD of FIG. 4 includes three affiliated APs. In the example of FIG. 4, AP1 may operate in the 2.4 GHz band, AP2 may operate in the 5 GHz band, and AP3 may operate in the 6 GHz band. In the example of FIG. 4, the first link in which AP1 and non-AP1 operate may be defined as a channel/subchannel/frequency resource within the 2.4 GHz band. In addition, in the example of FIG. 4, the second link in which AP2 and non-AP2 operate may be defined as a channel/subchannel/frequency resource within the 5 GHz band. In addition, in the example of FIG. 4, the third link where AP3 and non-AP3 operate can be defined as a channel/subchannel/frequency resource within the 6 GHz band.

In the example of FIG. 4, AP1 can start a multi-link setup procedure (ML setup procedure) by transmitting an association request frame to non-AP STA1. In the example of FIG. 4, non-AP STA1 can transmit an association response frame in response to the association request frame. Each AP (e.g., AP1/2/3) illustrated in FIG. 4 may be identical to the AP illustrated in FIG. 1 and/or FIG. 2, and each non-AP (e.g., non-AP1/2/3) illustrated in FIG. 4 may be identical to the STA (i.e., user-STA or non-AP STA) illustrated in FIG. 1 and/or FIG. 2.

The specific features of the present disclosure are not limited to the specific features of FIG. 4. That is, the number of links can be defined in various ways, and multiple links can be defined in various ways within at least one band.

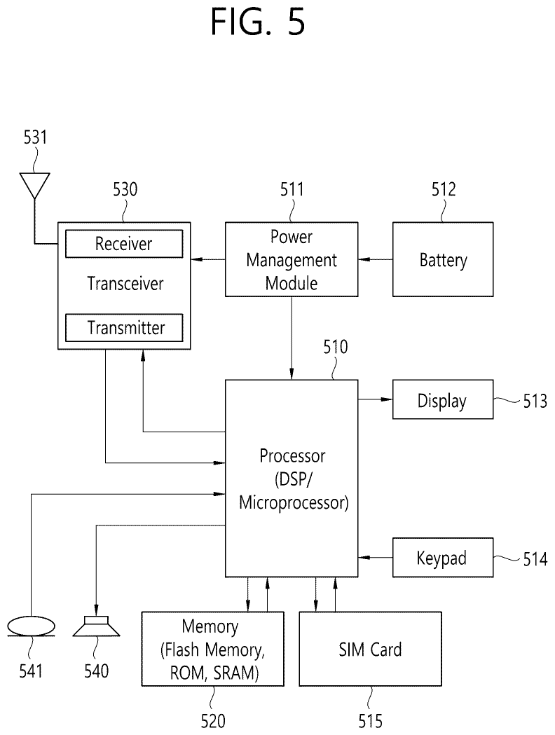

FIG. 5 illustrates a modified example of a transmitting device and/or a receiving device of the present disclosure.

The devices (e.g., AP STA, non-AP STA) shown in FIGS. 1 to 4 can be modified as shown in FIG. 5. The transceiver 530 of FIG. 5 can be identical to the transceiver 113, 123 of FIG. 1. The transceiver 530 of FIG. 5 can include a receiver and a transmitter.

The processor 510 of FIG. 5 can be identical to the processor 111, 121 of FIG. 1. Alternatively, the processor 510 of FIG. 5 can be identical to the processing chip 114, 124 of FIG. 1.

The memory 150 of FIG. 5 may be the same as the memory 112, 122 of FIG. 1. Alternatively, the memory 150 of FIG. 5 may be a separate external memory different from the memory 112, 122 of FIG. 1.

Referring to FIG. 5, the power management module 511 manages power for the processor 510 and/or the transceiver 530. The battery 512 supplies power to the power management module 511. The display 513 outputs the result processed by the processor 510. The keypad 514 receives input to be used by the processor 510. The keypad 514 may be displayed on the display 513. The SIM card 515 may be an integrated circuit used to securely store an international mobile subscriber identity (IMSI) and its associated keys, which are used to identify and authenticate subscribers in mobile devices such as mobile phones and computers.

Referring to FIG. 5, the speaker (540) may output sound-related results processed by the processor 510. The microphone (541) may receive sound-related input to be used by the processor 510.

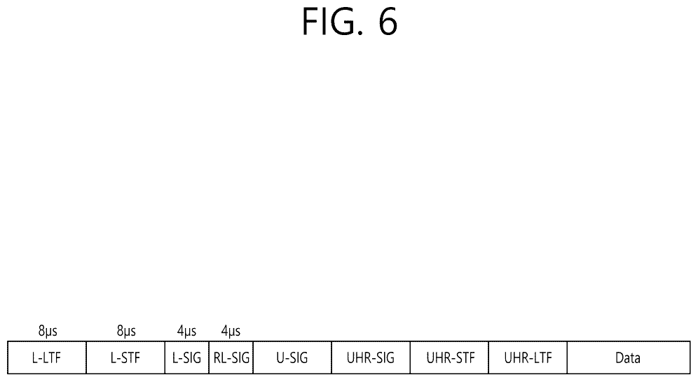

FIG. 6 illustrates an example of a physical protocol data unit or physical layer (PHY) protocol data unit (PPDU) transmitted/received by an STA of the present disclosure.

An STA (e.g., an AP STA, a non-AP STA, an AP MLD, a non-AP MLD) of the present disclosure can transmit and/or receive a PPDU of FIG. 6. The PPDU described in the present disclosure can have, for example, a structure of FIG. 6. In addition, the PPDU described in the present disclosure can be called by various names such as a transmission PPDU, a reception PPDU, a first type or an Nth type PPDU, etc. The PPDU described in the present disclosure can be used in a WLAN system defined according to IEEE 802.11bn and/or a next-generation WLAN system that improves IEEE 802.11bn.

The PPDU of FIG. 6 can be related to various PPDU types used in a UHR system. For example, the example of FIG. 6 can be used for at least one of single-user (SU) mode/type/transmission, multi-user (MU) mode/type/transmission, and null-data packet (NDP) mode/type/transmission related to channel sounding. For example, if the example of FIG. 6 is related to NDP, the data field illustrated can be omitted. If the PPDU of FIG. 6 is used for trigger-based (TB) mode, UHR-SIG of FIG. 6 can be omitted. In other words, an STA that has received a trigger frame for uplink-MU (UL-MU) communication can transmit a PPDU with UHR-SIG omitted in the example of FIG. 6.

In FIG. 6, L-STF or UHR-LTF may be called a preamble or a physical preamble, and may be generated/transmitted/received/acquired/decoded in the physical layer (included in the transmitting/receiving STA).

Each block illustrated in FIG. 6 may be called a field/subfield/signal, etc. The names of these fields/subfields/signals may be legacy short training field (L-STF), legacy long training field (L-LTF), legacy signal (L-SIG), repeated L-SIG (RL-SIG), universal signal (U-SIG), UHR-signal (UHR-SIG), etc., as illustrated in FIG. 6.

A subcarrier spacing of the L-STF, L-LTF, L-SIG, RL-SIG, U-SIG, and UHR-SIG fields of FIG. 6 may be determined as 312.5 kHz, and a subcarrier spacing of the UHR-STF, UHR-LTF, and Data fields may be determined as 78.125 kHz. That is, a tone index (or subcarrier index) of the L-STF, L-LTF, L-SIG, RL-SIG, U-SIG, and UHR-SIG fields may be expressed in unit of 312.5 kHz, and a tone index (or subcarrier index) of the UHR-STF, UHR-LTF, and Data fields may be expressed in unit of 78.125 kHz.

In the PPDU of FIG. 6, the L-LTF and the L-STF may be the same as those in the conventional fields (for example, non-HT LTF and non-HT STF defined in conventional WLAN standards).

The L-SIG field of FIG. 6 may include, for example, bit information of 24 bits. For example, the 24-bit information may include a rate field of 4 bits, a reserved bit of 1 bit, a length field of 12 bits, a parity bit of 1 bit, and a tail bit of 6 bits. For example, the length field of 12 bits may include information related to a length or time duration of a PPDU. For example, the length field of 12 bits may be determined based on a type of the PPDU. For example, when the PPDU is a non-high throughput (HT), high throughput (HT), very high throughput (VHT) PPDU, extremely high throughput (EHT) PPDU or UHR PPDU, a value of the length field may be determined as a multiple of 3. For example, when the PPDU is an HE PPDU, the value of the length field may be determined as “a multiple of 3”+1 or “a multiple of 3”+2. In other words, for the non-HT, HT, VHT PPDI, EHT PPDU or the UHR PPDU, the value of the length field may be determined as a multiple of 3, and for the high efficiency (HE) PPDU, the value of the length field may be determined as “a multiple of 3”+1 or “a multiple of 3”+2. In other words, the LENGTH field in an UHR PPDU is set to a value satisfying the condition that the remainder is zero when LENGTH is divided by 3

For example, the (non-AP and AP) STA may apply BCC encoding based on a 1/2 coding rate to the 24-bit information of the L-SIG field. Thereafter, the transmitting STA may obtain a BCC coding bit of 48 bits. BPSK modulation may be applied to the 48-bit coding bit, thereby generating 48 BPSK symbols. The transmitting STA may map the 48 BPSK symbols to positions except for a pilot subcarrier {subcarrier index −21, −7, +7, +21} and a DC subcarrier {subcarrier index 0}. As a result, the 48 BPSK symbols may be mapped to subcarrier indices −26 to −22, −20 to −8, −6 to −1, +1 to +6, +8 to +20, and +22 to +26. The transmitting STA may additionally map a signal of {-1, −1, −1, 1} to a subcarrier index {-28, −27, +27, +28}. The aforementioned signal may be used for channel estimation in the frequency domain corresponding to {-28, −27, +27, +28}.

For example, the (non-AP and AP) STA may generate an RL-SIG generated in the same manner as the L-SIG. BPSK modulation may be applied to the RL-SIG. The (non-AP and AP) STA may know that the RX PPDU is the HE PPDU, EHT PPDU, or the UHR PPDU, based on the presence of the RL-SIG. In other words, a receiving (non-AP and AP) STA can know that a received PPDU is one of a HE PPDU, an EHT PPDU, and a UHR PPDU if RL-SIG is present. In other words, a receiving (non-AP and AP) STA can know that a received PPDU is one of a non-HT PPDU, an HT PPDU, and a VHT PPDU if RL-SIG is not present. In other words, the RL-SIG field is a repeat of the L-SIG field and is used to differentiate a UHR PPDU from a non-HT PPDU, HT PPDU, and VHT PPDU.

A universal SIG (U-SIG) may be inserted after the RL-SIG of FIG. 6. The U-SIG may be called in various terms such as a first SIG field, a first SIG, a first type SIG, a control signal, a control signal field, a first (type) control signal, common control field, common control signal, or the like.

The U-SIG may include information of N bits, and may include information for identifying a type of the EHT PPDU. For example, the U-SIG may be configured based on two symbols (e.g., two contiguous OFDM symbols). Each symbol (e.g., OFDM symbol) for the U-SIG may have a duration of 4 us. Each symbol of the U-SIG may be used to transmit the 26-bit information. For example, each symbol of the U-SIG may be transmitted/received based on 52 data tomes and 4 pilot tones.

Through the U-SIG for example, A-bit information (e.g., 52 un-coded bits) may be transmitted. A first symbol of the U-SIG may transmit first X-bit information (e.g., 26 un-coded bits) of the A-bit information, and a second symbol of the U-SIG may transmit the remaining Y-bit information (e.g. 26 un-coded bits) of the A-bit information. For example, the transmitting STA may obtain 26 un-coded bits included in each U-SIG symbol. The transmitting STA may perform convolutional encoding (i.e., BCC encoding) based on a rate of R=1/2 to generate 52-coded bits, and may perform interleaving on the 52-coded bits. The transmitting STA may perform BPSK modulation on the interleaved 52-coded bits to generate 52 BPSK symbols to be allocated to each U-SIG symbol. One U-SIG symbol may be transmitted based on 65 tones (subcarriers) from a subcarrier index −28 to a subcarrier index +28, except for a DC index 0. The 52 BPSK symbols generated by the transmitting STA may be transmitted based on the remaining tones (subcarriers) except for pilot tones, i.e., tones −21, −7, +7, +21.

For example, the A-bit information (e.g., 52 un-coded bits) generated by the U-SIG may include a CRC field (e.g., a field having a length of 4 bits) and a tail field (e.g., a field having a length of 6 bits). The CRC field and the tail field may be transmitted through the second symbol of the U-SIG. The CRC field may be generated based on 26 bits allocated to the first symbol of the U-SIG and the remaining 16 bits except for the CRC/tail fields in the second symbol, and may be generated based on the conventional CRC calculation algorithm. In addition, the tail field may be used to terminate trellis of a convolutional decoder, and may be set to, for example, ‘000000’.

The A-bit information (e.g., 52 un-coded bits) transmitted by the U-SIG (or U-SIG field) may be divided into version-independent bits and version-dependent bits. For example, the version-independent bits may have a fixed or variable size. For example, the version-independent bits may be allocated only to the first symbol of the U-SIG, or the version-independent bits may be allocated to both of the first and second symbols of the U-SIG. For example, the version-independent bits and the version-dependent bits may be called in various terms such as a first control bit, a second control bit, or the like.

For example, the version-independent bits of the U-SIG may include a PHY version identifier of 3 bits. For example, the PHY version identifier of 3 bits may include information related to a PHY version of a TX/RX PPDU. For example, a first value of the PHY version identifier of 3 bits (for example, 000 value) may indicate that the TX/RX PPDU is an EHT PPDU. Also, a second value of the PHY version identifier of 3 bits (for example, 001 value) may indicate that the TX/RX PPDU is a UHR PPDU.

In other words, when the (AP/non-AP) STA transmits an EHT PPDU, the 3-bit PHY version identifier can be set to the first value, and when the (AP/non-AP) STA transmits a UHR PPDU, the 3-bit PHY version identifier can be set to the second value. In other words, the receiving (AP/non-AP) STA can determine that the received PPDU is an EHT PPDU based on the PHY version identifier having the first value, and can determine that the received PPDU is a UHR PPDU based on the PHY version identifier having the second value.

For example, the version-independent bits of the U-SIG may include a UL/DL flag field of 1 bit. A first value of the UL/DL flag field of 1 bit relates to UL communication, and a second value of the UL/DL flag field relates to DL communication.

For example, the version-independent bits of the U-SIG may include information related to a transmission opportunity (TXOP) length and information related to a BSS color ID.

For example, if a UHR PPDU is classified into various types (e.g., type related to SU transmission (performed based on UL or DL), type related to DL transmission, type related to NDP transmission, type related to DL non-MU-MIMO, type related to DL MU-MIMO, type related to multi-AP operation, type related to coordinated beamforming (CBF), spatial reuse (SR), type related to coordinated OFDMA (C-OFDMA), type related to coordinated TDMA (CTDMA)), information about the type of the UHR PPDU (e.g., 2-bit or 3-bit information) can be included in the version-dependent bits of the U-SIG.

For example, the U-SIG may include: 1) a bandwidth field including information related to a bandwidth; 2) a field including information related to an MCS applied to UHR-SIG; 3) an indication field including information regarding whether a dual subcarrier modulation (DCM) scheme is applied to UHR-SIG; 4) a field including information related to the number of symbol used for UHR-SIG; 5) a field including information regarding whether the UHR-SIG is generated across a full band; 6) a field including information related to a type of UHR-LTF/STF; and 7) information related to a field indicating an UHR-LTF length and a CP length.

Preamble puncturing may be applied to the PPDU of FIG. 6. The preamble puncturing implies that puncturing is applied to part (e.g., a secondary 20 MHz band) of the full band. For example, when an 80 MHz PPDU is transmitted, an STA may apply puncturing to the secondary 20 MHz band out of the 80 MHz band, and may transmit a PPDU only through a primary 20 MHz band and a secondary 40 MHz band.

For example, a pattern of the preamble puncturing may be configured in advance. For example, when a first puncturing pattern is applied, puncturing may be applied only to the secondary 20 MHz band within the 80 MHz band. For example, when a second puncturing pattern is applied, puncturing may be applied to only any one of two secondary 20 MHz bands included in the secondary 40 MHz band within the 80 MHz band. For example, when a third puncturing pattern is applied, puncturing may be applied to only the secondary 20 MHz band included in the primary 80 MHz band within the 160 MHz band (or 80+80 MHz band). For example, when a fourth puncturing is applied, puncturing may be applied to at least one 20 MHz channel not belonging to a primary 40 MHz band in the presence of the primary 40 MHz band included in the 80 Mhaz band within the 160 MHz band (or 80+80 MHz band).

Information related to the preamble puncturing applied to the PPDU may be included in U-SIG and/or UHR-SIG. For example, a first field of the U-SIG may include information related to a contiguous bandwidth, and second field of the U-SIG may include information related to the preamble puncturing applied to the PPDU.

For example, the U-SIG and the UHR-SIG may include the information related to the preamble puncturing, based on the following method. When a bandwidth of the PPDU exceeds 80 MHz, the U-SIG may be configured individually in unit of 80 MHz. For example, when the bandwidth of the PPDU is 160 MHz, the PPDU may include a first U-SIG for a first 80 MHz band and a second U-SIG for a second 80 MHz band. In this case, a first field of the first U-SIG may include information related to a 160 MHz bandwidth, and a second field of the first U-SIG may include information related to a preamble puncturing (i.e., information related to a preamble puncturing pattern) applied to the first 80 MHz band. In addition, a first field of the second U-SIG may include information related to a 160 MHz bandwidth, and a second field of the second U-SIG may include information related to a preamble puncturing (i.e., information related to a preamble puncturing pattern) applied to the second 80 MHz band. Meanwhile, an UHR-SIG contiguous to the first U-SIG may include information related to a preamble puncturing applied to the second 80 MHz band (i.e., information related to a preamble puncturing pattern), and an UHR-SIG contiguous to the second U-SIG may include information related to a preamble puncturing (i.e., information related to a preamble puncturing pattern) applied to the first 80 MHz band.

Additionally or alternatively, the U-SIG and the UHR-SIG may include the information related to the preamble puncturing, based on the following method. The U-SIG may include information related to a preamble puncturing (i.e., information related to a preamble puncturing pattern) for all bands. That is, the UHR-SIG may not include the information related to the preamble puncturing, and only the U-SIG may include the information related to the preamble puncturing (i.e., the information related to the preamble puncturing pattern).

The U-SIG may be configured in unit of 20 MHz. For example, when an 80 MHz PPDU is configured, the U-SIG may be duplicated. That is, four identical U-SIGs may be included in the 80 MHz PPDU. PPDUs exceeding an 80 MHz bandwidth may include different U-SIGs.

The UHR-SIG of FIG. 6 may include control information for the receiving STA. The UHR-SIG may be transmitted through at least one symbol, and one symbol may have a length of 4 us. Information related to the number of symbols used for the UHR-SIG may be included in the U-SIG.

UHR-SIG provides an additional signal to the U-SIG field to enable STA to interpret/decode UHR PPDU. UHR-SIG field may include U-SIG overflow bits that are commonly applied to all users. In addition, UHR-SIG field includes resource allocation information, so that STA can look-up resources used in fields including data field/UHR-STF/UHR-LTF (i.e., UHR modulated fields of a UHR PPDU).

Frequency resources of UHR-LTF, UHR-STF, and data fields illustrated in FIG. 6 may be determined based on Rus (resource units) defined by multiple subcarriers/tones. That is, UHR-LTF, UHR-STF, and data fields of the present disclosure may be transmitted/received through Rus (resource units) defined by multiple subcarriers/tones.

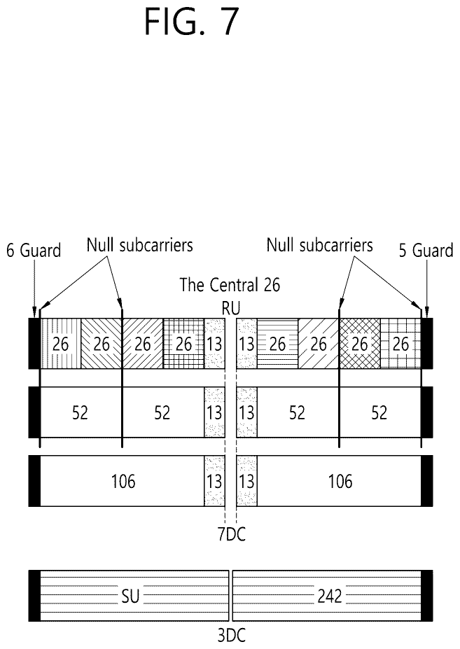

FIG. 7 illustrates the layout of resource units (Rus) used for a 20 MHz PPDU. That is, the UHR-LTF, UHR-STF, and/or data fields included in the 20 MHz PPDU can be transmitted/received through at least one of the various Rus defined in FIG. 7.

As illustrated in the uppermost part of FIG. 7, a 26-unit (i.e., a unit corresponding to 26 tones) may be disposed. Six tones may be used for a guard band in the leftmost band of the 20 MHz band, and five tones may be used for a guard band in the rightmost band of the 20 MHz band. Further, seven DC tones may be inserted in a center band, that is, a DC band, and a 26-unit corresponding to 13 tones on each of the left and right sides of the DC band may be disposed. A 26-unit, a 52-unit, and a 106-unit may be allocated to other bands. Each unit may be allocated for a receiving STA, that is, a user.

The layout of the Rus in FIG. 7 may be used not only for a multiple users (Mus) but also for a single user (SU), in which case one 242-unit may be used and three DC tones may be inserted as illustrated in the lowermost part of FIG. 7.

Although FIG. 7 proposes Rus having various sizes, that is, a 26-RU, a 52-RU, a 106-RU, and a 242-RU, specific sizes of Rus may be extended or increased. Therefore, the present embodiment is not limited to the specific size of each RU (i.e., the number of corresponding tones). In the present disclosure, N-RU may be represented as N-tone RU, etc. For example, 26-RU may be represented as 26-tone RU.

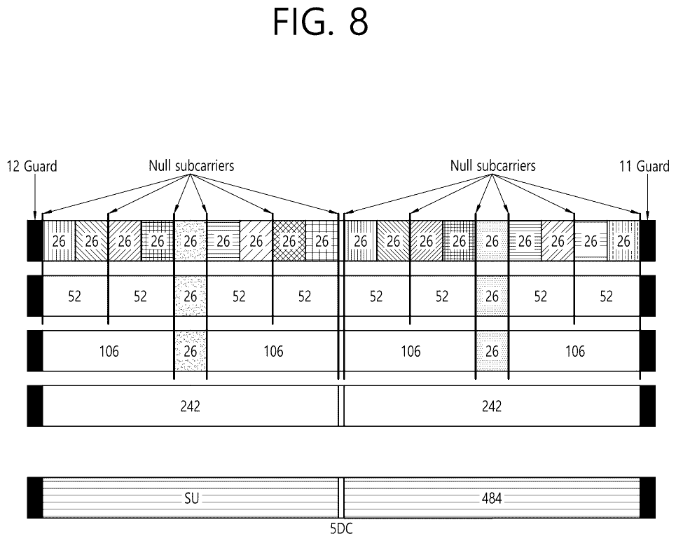

FIG. 8 illustrates the layout of resource units (Rus) used for 40 MHz PPDU.

Similarly to FIG. 7 in which Rus having various sizes are used, a 26-RU, a 52-RU, a 106-RU, a 242-RU, a 484-RU, and the like may be used in an example of FIG. 8. Further, five DC tones may be inserted in a center frequency, 12 tones may be used for a guard band in the leftmost band of the 40 MHz band, and 11 tones may be used for a guard band in the rightmost band of the 40 MHz band.

As illustrated in FIG. 8, when the layout of the Rus is used for a single user, a 484-RU may be used. The specific number of Rus may be changed similarly to FIG. 7.

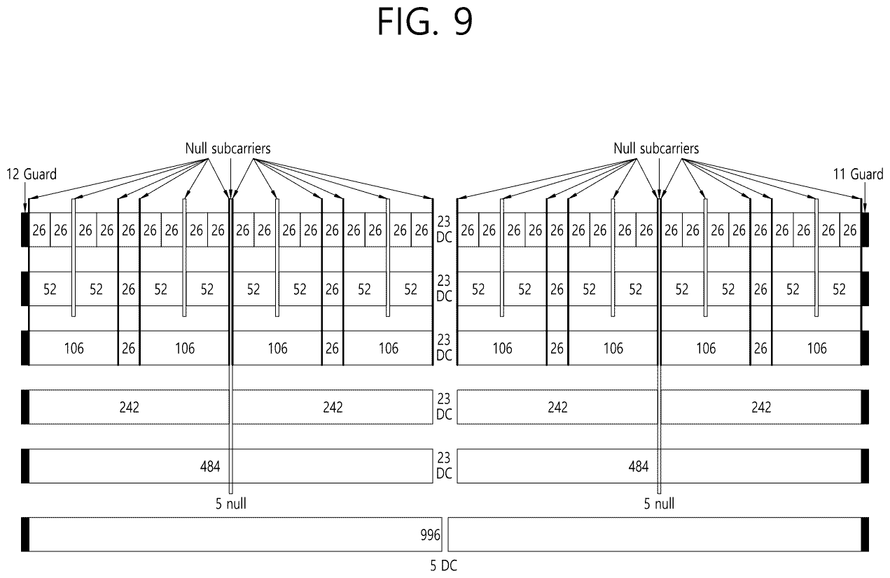

FIG. 9 illustrates the layout of resource units (Rus) used for an 80 MHz PPDU. The layout of the resource units (Rus) used in the present disclosure may vary. For example, the layout of the resource units (Rus) used in the 80 MHz band may vary.

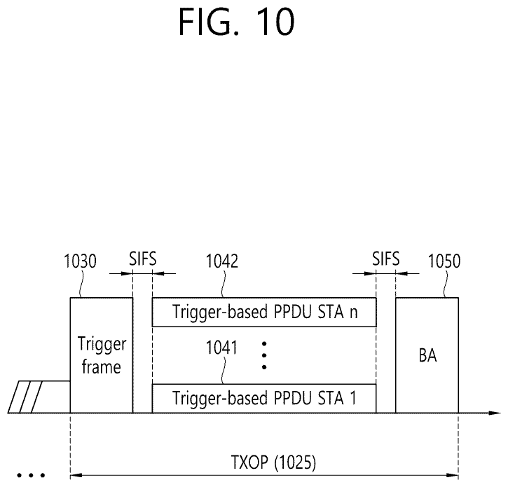

FIG. 10 illustrates an operation related to UL-MU. As shown, a transmitting STA (e.g., AP) can obtain TXOP 1025 by performing channel access through contending (i.e., backoff operation) and transmit trigger frame 1030. That is, the transmitting STA (e.g., AP) can transmit PPDU including trigger frame 1030. When PPDU including trigger frame is received, trigger-based (TB) PPDU is transmitted after delay of SIFS.

TB PPDU 1041, 1042 can be transmitted at the same time and transmitted from multiple STA (e.g., user STA) whose AID is indicated in trigger frame 1030. ACK frame 1050 for TB PPDU can be implemented in various forms. For example, ACK frame 1050 for TB PPDU can be implemented in the form of block ACK (BA).

In FIG. 10, transmission(s) of trigger Frame 1030, TB PPDU 1041, 1042 and/or ACK Frame 1050 can be performed within TXOP 1025.

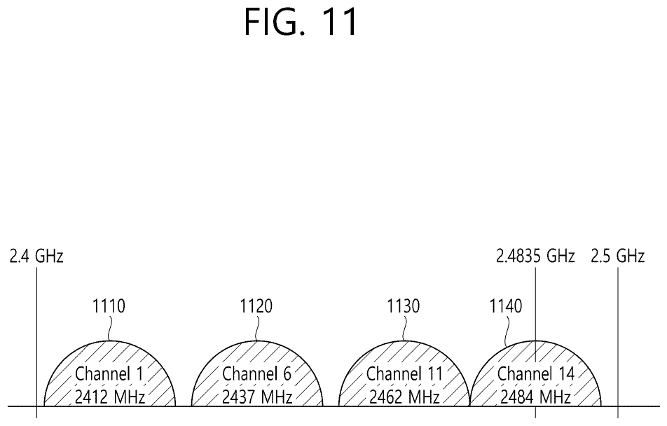

FIG. 11 illustrates an example of channels used/supported/defined within the 2.4 GHz band.

The 2.4 GHz band may also be referred to by other names, such as “first band.” Furthermore, the 2.4 GHz band may refer to a frequency range in which channels with a center frequency adjacent to 2.4 GHz (e.g., channels with a center frequency between 2.4 and 2.5 GHz) are used/supported/defined.

The 2.4 GHz band may include multiple 20 MHz channels. Each 20 MHz within the 2.4 GHz band may have multiple channel indices (e.g., indices 1 through 14). For example, the center frequency of a 20 MHz channel assigned with channel index 1 may be 2.412 GHz, the center frequency of a 20 MHz channel assigned with channel index 2 may be 2.417 GHz, and the center frequency of a 20 MHz channel assigned with channel index N may be (2.407+0.005*N) GHz. Channel indices may be referred to by various names, such as channel numbers. The specific numerical values of the channel indices and center frequencies may vary.

FIG. 11 illustrates examples of four channels within the 2.4 GHz band. The illustrated first frequency region 1110 to fourth frequency regions 1140 may each include one channel. For example, the first frequency region 1110 may include channel 1 (a 20 MHz channel with index 1). In this case, the center frequency of channel 1 may be set to 2412 MHz. The second frequency range 1120 may include channel 6. The center frequency of channel 6 may be set to 2437 MHz. The third frequency range 1130 may include channel 11. The center frequency of channel 11 may be set to 2462 MHz. The fourth frequency range 1140 may include channel 14. The center frequency of channel 14 may be set to 2484 MHz.

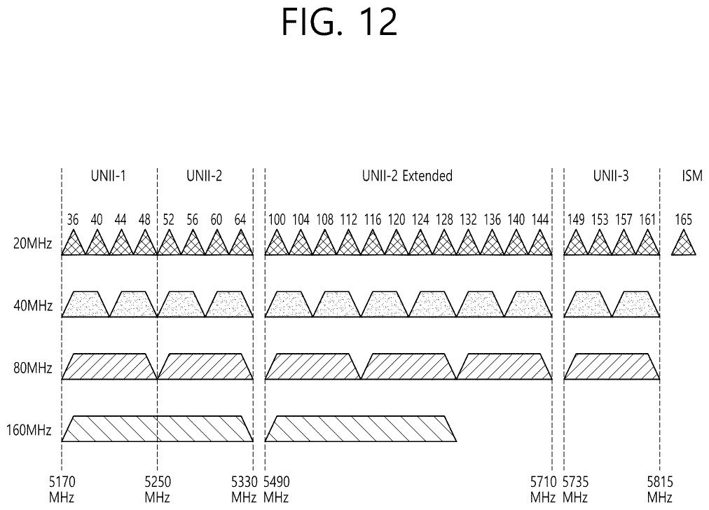

FIG. 12 illustrates an example of channels used/supported/defined within the 5 GHz band.

The 5 GHz band may be referred to by other names, such as “second band” or “band.” The 5 GHz band may refer to a frequency range in which channels with a center frequency of 5 GHz or more but less than 6 GHZ (or less than 5.9 GHZ) are used/supported/defined. Alternatively, the 5 GHz band may include multiple channels between 4.5 GHZ and 5.5 GHz. The specific numerical values shown in FIG. 12 may vary.

The multiple channels within the 5 GHz band include Unlicensed National Information Infrastructure (UNII)-1, UNII-2, UNII-3, and ISM. UNII-1 may be referred to as UNII Low. UNII-2 may include frequency ranges called UNII Mid and UNII-2Extended. UNII-3 may be referred to as UNII-Upper.

Multiple channels may be configured within the 5 GHz band, and the bandwidth of each channel may vary, such as 20 MHz, 40 MHz, 80 MHz, or 160 MHz. For example, the 5170 MHz to 5330 MHz frequency range within UNII-1 and UNII-2 may be divided into eight 20 MHz channels. The 5170 MHz to 5330 MHz frequency range can be divided into four channels across a 40 MHz frequency band. The 5170 MHz to 5330 MHz frequency range can be divided into two channels across an 80 MHz frequency band. Alternatively, the 5170 MHz to 5330 MHz frequency range can be divided into one channel across a 160 MHz frequency band.

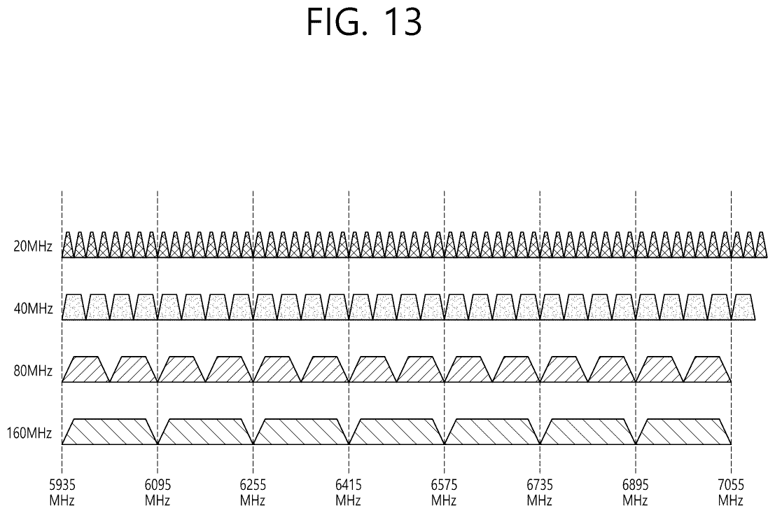

FIG. 13 illustrates an example of channels used, supported, and defined within the 6 GHz band.

The 6 GHz band may also be referred to by other names, such as the third band. The 6 GHz band may refer to a frequency range in which channels with center frequencies above 5.9 GHz are used, supported, and defined. The specific numbers shown in FIG. 13 may vary.

For example, the 20 MHz channel in FIG. 13 may be defined starting from 5.940 GHz. Specifically, the leftmost channel among the 20 MHz channels in FIG. 13 may have an index of 1 (or channel index, channel number, etc.), and a center frequency of 5.945 GHz may be assigned. That is, the center frequency of the index N channel may be determined as (5.940+0.005*N) GHz.

Accordingly, the indexes (or channel numbers) of the 20 MHz channels of FIG. 13 are 1, 5, 9, 13, 17, 21, 25, 29, 33, 37, 41, 45, 49, 53, 57, 61, 65, 69, 73, 77, 81, 85, 89, 93, 97, 101, 105, 109, 113, 117, 121, 125, 129, 133, 137, 141, 145, 149, 153, 157, 161, 165, 169, 173, 177, 181, 185, 189, 193, It can be 197, 201, 205, 209, 213, 217, 221, 225, 229, 233. Also, according to the (5.940+0.005*N) GHz rule mentioned above, the indices of the 40 MHz channels in FIG. 13 can be 3, 11, 19, 27, 35, 43, 51, 59, 67, 75, 83, 91, 99, 107, 115, 123, 131, 139, 147, 155, 163, 171, 179, 187, 195, 203, 211, 219, 227.

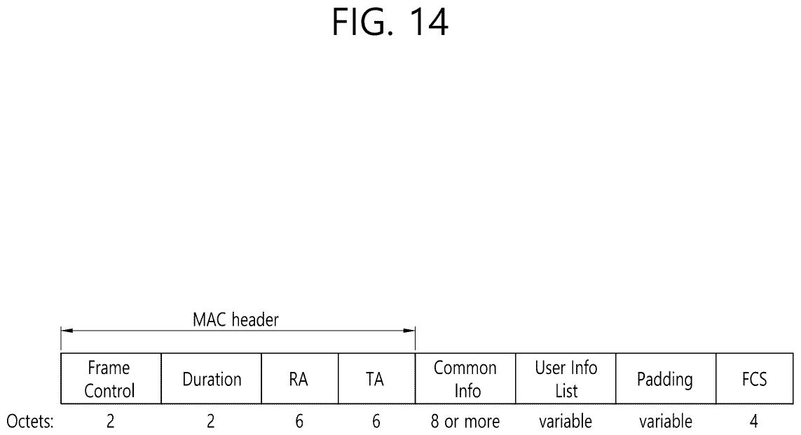

FIG. 14 illustrates a trigger frame format. The trigger frame format may also be referred to as the structure of a trigger frame.

Referring to FIG. 14, a trigger frame may include a frame control field, a duration field, a receiver address (RA) field, a transmitter address (TA) field, a Common Info field, a User Info list field, a padding field, and/or a frame check sequence (FCS) field. Optionally, the trigger frame may further comprise a special User Info field between the Common Info field and the User Info list field. The User Info list field may include one or more User Info fields. The frame control field, duration field, RA field, and TA field may constitute a MAC header.

The Common Info field may include a HE variant Common Info field and/or an EHT variant Common Info field. The User Info field may also include a HE variant User Info field and/or an EHT variant User Info field.

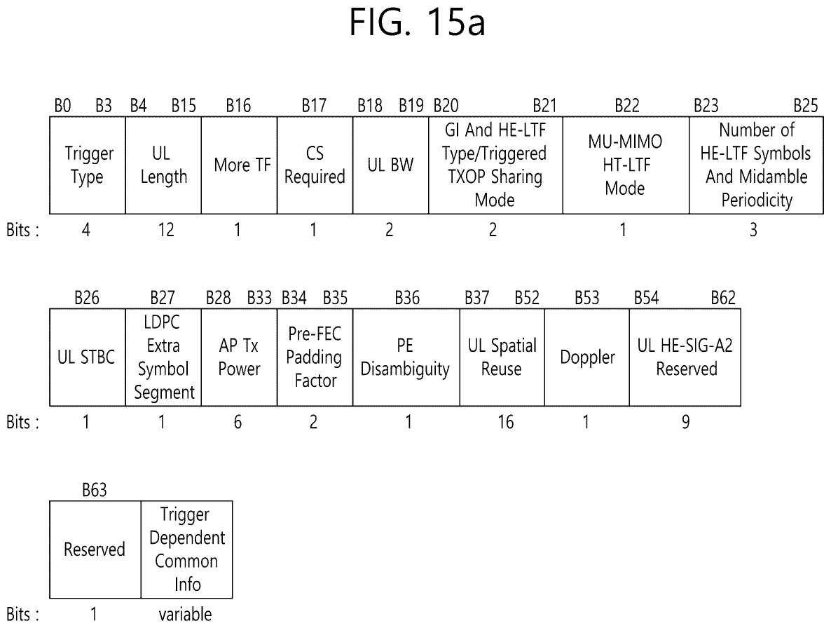

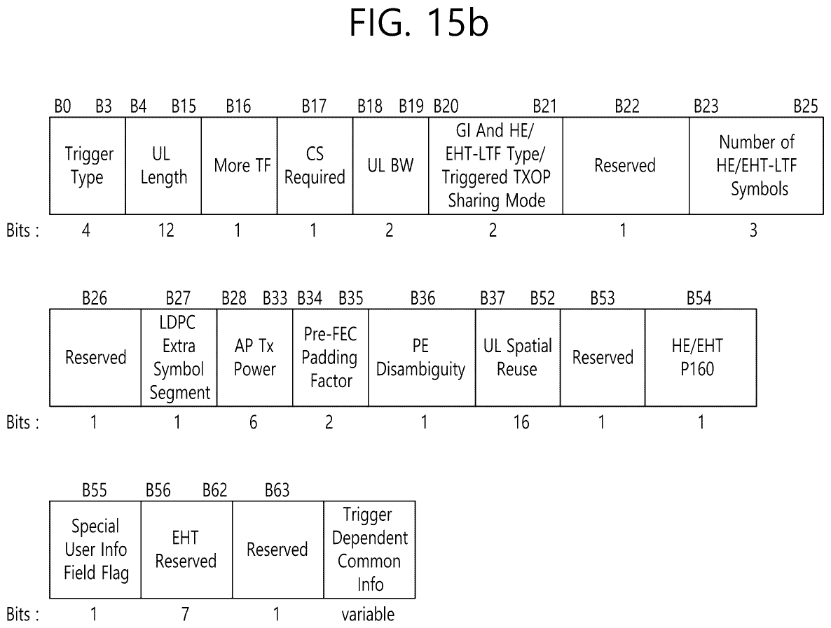

FIG. 15a illustrates HE variant Common Info field format. The HE variant Common Info field format may also be referred to as the structure of the HE variant Common Info field.

Referring to FIG. 15a, the HE variant Common Info field may include various subfields. For example, the HE variant Common Info field may include a trigger type subfield (B0-B3, 4 bits), a reserved subfield (B63, 1 bit), and/or a trigger dependent Common Info subfield (variable bit size).

FIG. 15b illustrates the EHT variant Common Info field format. The EHT variant Common Info field format may also be referred to as the structure of the EHT variant Common Info field.

Referring to FIG. 15b, the EHT variant Common Info field may include various subfields. For example, the EHT variant Common Info field may include a trigger type subfield (B0-B3, 4 bits), a reserved subfield (B63, 1 bit), and/or a trigger dependent Common Info subfield (variable bit size).

In FIGS. 15a and 15b, the trigger type subfield value of the HE variant Common Info field and/or the EHT variant Common Info field may indicate a trigger frame variant as shown in <Table 1>:

TABLE 1

| Trigger type | |
|---|---|
| subfield value | Trigger frame variant |
| 0 | Basic |
| 1 | Beamforming Report Poll (BFRP) |
| 2 | MU-BAR |
| 3 | MU-RT |
| 4 | Buffer Status Report Poll (BSRP) |
| 5 | GCR MU-BAR |
| 6 | Bandwidth Query Report Poll (BQRP) |
| 7 | NDP Feedback Report Poll (NFRP) |
| 8-15 | Reserved |

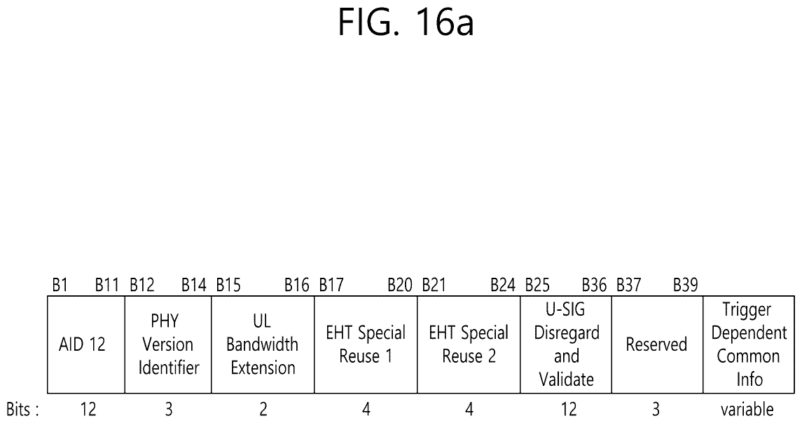

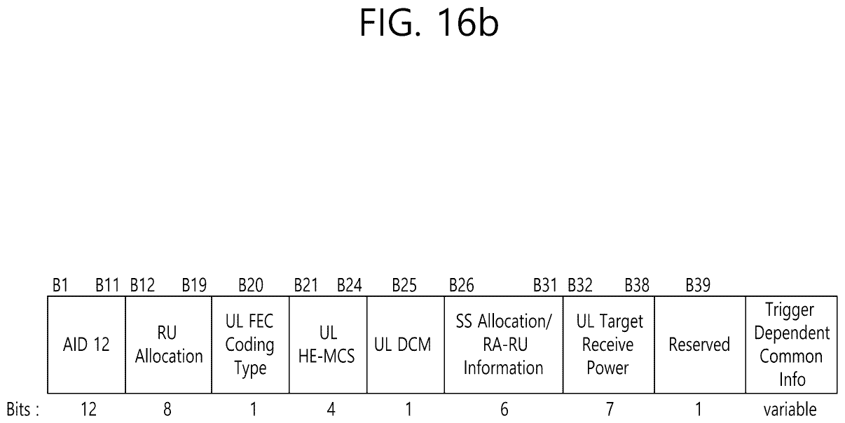

FIG. 16a illustrates an HE variant User Info field format. FIG. 16b illustrates the EHT variant User Info field format. The HE/EHT variant User Info field format may also be referred to as the structure of the HE/EHT variant User Info field. Referring to FIGS. 16a and 16b, the HE/EHT variant User Info field may include various subfields. Hereinafter, a description will be given of preamble puncturing.

Preamble puncturing refers to a transmission of a PPDU in which there is no signal on at least one 20 MHz channel/subchannel within the PPDU bandwidth. Preamble puncturing may result from a situation in which a 20 MHz channel/subchannel within the PPDU bandwidth cannot be used, such as when a channel/subchannel is indicated as busy by channel clear assessment (CCA) and/or when a bit is set in the Disabled Subchannel Bitmap subfield (of an EHT Operation element).

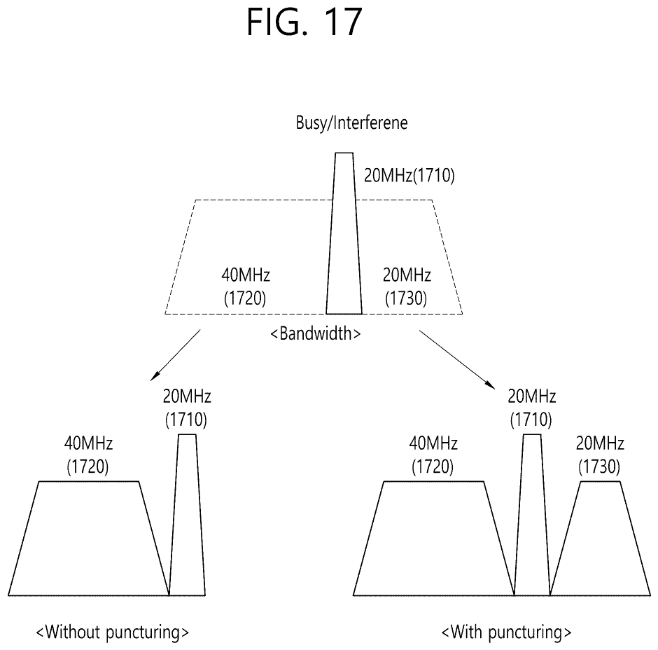

FIG. 17 illustrates an example in which preamble puncturing is applied.

Referring to FIG. 17, in the entire 80 MHz band, a portion of the 20 MHz band 1710 may be busy and/or interfered with by another signal. If preamble puncturing is not applied, since the available channels must all be continuous and in an idle state (i.e., free from interference and/or congestion), only a contiguous 40 MHz band 1720 composed of two 20 MHz channels, or a single 20 MHz band 1730, may be used. That is, without preamble puncturing, the 40 MHz band 1720 and the 20 MHz band 1730 cannot be used together.

In contrast, when preamble puncturing is applied, a PPDU having no signal in the 20 MHz band 1710 may be transmitted over the entire 80 MHz band. In this case, the 40 MHz band 1720 and the 20 MHz band 1730 may effectively be used together. A transmitting STA may generate a PPDU for the entire 80 MHz band but puncture the signal corresponding to the 20 MHz band 1710, thereby transmitting a PPDU without a signal on the 20 MHz band 1710 over the entire 80 MHz band. The 20 MHz band 1710 may be referred to as a preamble-punctured channel and/or a punctured channel. The transmitting STA may also transmit preamble puncturing information (e.g., Punctured Channel Information) indicating the punctured channel to the receiving STA. The receiving STA may receive the PPDU over the entire 80 MHz band using a single radio frequency (RF) chain, but may refrain from decoding the signal corresponding to the 20 MHz band 1710 indicated by the puncturing information, and may decode the signals corresponding to the remaining 40 MHz band 1720 and 20 MHz band 1730. Accordingly, when preamble puncturing is applied, a PPDU mapped to non-contiguous channels/subchannels may be transmitted to the receiving STA, and the receiving STA may decode the PPDU using only a single RF chain.

In FIG. 17, the 20 MHz band 1710 that is busy and/or interfered with by another signal may be referred to as “disabled channel”, while the remaining 40 MHz band 1720 and 20 MHz band 1730 may be referred to as “available channel”. Preamble puncturing may be applied not only to disabled channels but also to available channels, and a channel to which preamble puncturing is applied may be referred to as “punctured channel”.

Preamble puncturing may be present in a MU PPDU transmitted in the DL or UL direction, as well as in a TB PPDU transmitted by a non-AP STA in the UL direction. In the case of a MU PPDU, information for preamble puncturing may be comprised in the MU PPDU. For example, in an EHT MU PPDU, information for preamble puncturing may be comprised in the U-SIG and EHT-SIG fields.

When OFDMA transmission is used for a bandwidth greater than 40 MHz, and non-OFDMA transmission is used for 80 MHz or 160 MHz PPDU bandwidths, the preamble puncturing resolution may be 20 MHz. In this case, puncturing for a channel/subchannel smaller than a 242-tone RU may not be allowed. For a MU PPDU using non-OFDMA transmission with a 320 MHz PPDU bandwidth, the preamble puncturing resolution may be 40 MHz. That is, in non-OFDMA transmission, puncturing for a channel/subchannel smaller than a 484-tone RU may not be allowed within a 320 MHz PPDU bandwidth.

Preamble puncturing may not be applied to the primary 20 MHz channel/subchannel of a MU PPDU.

An AP may add a Disabled Subchannel Bitmap subfield to (an EHT Operation element comprised in) a management frame. When the AP punctures a channel/subchannel for the BSS, the AP shall set the Disabled Subchannel Bitmap Present subfield to 1 and shall comprise the Disabled Subchannel Bitmap subfield (in the EHT Operation element). Otherwise (i.e., when no channel/subchannel is punctured), the AP shall set the Disabled Subchannel Bitmap Present subfield to 0 and shall not comprise the Disabled Subchannel Bitmap subfield (in the EHT Operation element). The puncturing pattern indicated by the Disabled Subchannel Bitmap subfield shall be one of the non-OFDMA puncturing patterns defined according to the punctured channel information field of the U-SIG for a MU PPDU using non-OFDMA transmission. The AP may set each bit of the Disabled Subchannel Bitmap subfield according to the following constraints:
The result of the puncturing pattern shall correspond to one of the puncturing patterns defined according to the channel information field.
Bits corresponding to 20 MHz channels/subchannels outside the BSS bandwidth shall be set to 1.
The bit corresponding to the primary 20 MHz channel/subchannel shall be set to 0.

The Disabled Subchannel Bitmap subfield may be a 16-bit bitmap. In the 16-bit bitmap, the least significant bit may correspond to a 20 MHz channel/subchannel within the BSS bandwidth having the lowest frequency among all 20 MHz channel/subchannel sets within the BSS bandwidth. Each successive bit in the bitmap may correspond to the next higher-frequency 20 MHz channel/subchannel. Bits within the BSS bandwidth may be set to 1 to indicate that the corresponding 20 MHz channel/subchannel is punctured, and may be set to 0 to indicate that it is not punctured. Bits outside the BSS bandwidth may be reserved

Below, channel sounding is described as an example of channel measurement.

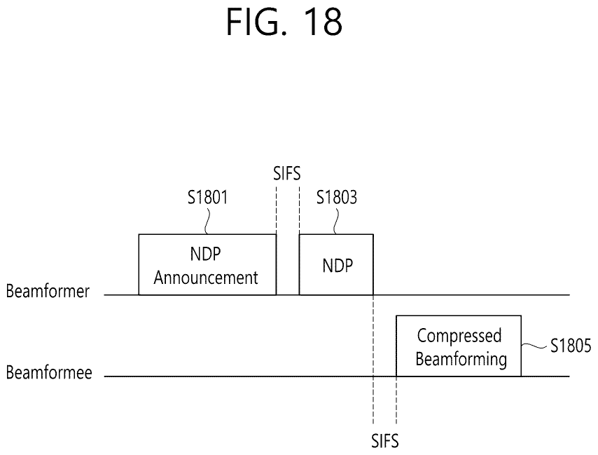

FIG. 18 illustrates an example of a channel sounding procedure.

Referring to FIG. 18, channel sounding is initiated by a first STA, called a beamformer. Channel sounding may be performed between the beamformer and a second STA, called a beamformee. For DL channel measurement, the beamformer may be an AP STA, and the beamformee may be a non-AP STA. For UL channel measurements, the beamformer may be a non-AP STA, and the beamformee may be an AP STA.

In step S1801, the beamformer may initiate channel sounding by transmitting a Null Data Packet Announcement (NDPA) frame, which is used to control the channel and identify the beamformee, to the beamformee. The number of beamformees may be one or more. If the number of beamformees is N, the NPDA may include N STA information fields. Each STA information field is associated with a corresponding beamformee and may include information for the corresponding beamformee (e.g., information identifying the beamformee). At least one beamformee performs a response to the NDPA frame. STAs other than the beamformee may defer channel access until the sounding sequence (i.e., sequential frame exchange for sounding) is completed.

In step S1803, after the NDPA frame is transmitted, the beamformer may transmit a Null Data Packet (NDP) frame. The NDP is defined based on the VHT/HE/EHT/UHR PPDU.

For example, the NDP may be a PPDU in which a data field corresponding to a payload signal (or MAC data) is omitted from the VHT/HE/EHT/UHR PPDU. Since the NDP includes multiple OFDM training fields, the beamformee receiving the NDP may calculate a channel response. In addition, the NDP may be used to calculate a steering matrix (e.g., a Q matrix) related to beamforming. In some cases, multiple NDPs may be configured for multiple beamformees. As illustrated, an interframe space of Short Interframe Space (SIFS) may exist between the NDPA frame and the NDP frame. That is, an NDP frame may be transmitted after to SIFS has elapsed since the NDPA frame is transmitted.

In step S1805, the beamformee can calculate a feedback matrix/channel quality indicator (CQI) based on the received NDP. In other words, the beamformee can perform channel measurements based on the received NDP and obtain channel information including the results of the channel measurements (e.g., the feedback matrix/CQI). The feedback matrix, expressed by various names such as V matrix, enables the beamformer to calculate a steering matrix. The beamformee transmits a feedback/report signal containing the channel information to the beamformer. The beamformer can calculate a steering matrix based on the feedback/report signal, for example, for communications directed to the beamformee. The channel information and/or the feedback/report signal may include a compressed beamforming signal, as illustrated.

If only one beamformee exists, the beamformee can transmit the feedback/report signal to the beamformer after SIFS has elapsed since receiving the NDP.

When multiple beamformees exist, they can sequentially transmit feedback/report signals. The beamformee associated with the first STA information field among the STA information fields can transmit the feedback/report signal to the beamformer after SIFS has elapsed since receiving the NDP, without receiving a separate polling frame. Conversely, the remaining beamformees can transmit the feedback/report signal to the beamformer after a SIFS has elapsed since receiving a polling frame (e.g., a BFRP frame) transmitted by the beamformer. Here, the polling frame can be transmitted after SIFS has elapsed since the feedback/report signal is transmitted/received.

When multiple beamformees exist, multiple beamformees can simultaneously transmit feedback/report signals through Rus allocated via a trigger frame. For example, the trigger frame can be a beamforming report poll (BFRP) trigger frame. A BFRP trigger frame may include information for identifying beamformees (e.g., AID/12 LSB) and information for frequency resources (i.e., Rus) for each beamformee to transmit feedback/report signals. Beamformees identified by the BFRP trigger frame may transmit feedback/report signals (simultaneously/together) based on the corresponding RU resources. The BFRP trigger frame may be transmitted after SIFS has elapsed since the NDP is transmitted/received. The feedback/report signals of multiple beamformees may be transmitted after SIFS has elapsed since the BFRP trigger frame is transmitted/received.

Meanwhile, in next-generation wireless LAN systems, signal transmission and reception using relays (i.e., relay operation) may be considered to ensure stable and/or reliable signal transmission regardless of the location of STAs within the BSS, increase signal transmission coverage, and/or eliminate signal inaccessibility. For relay operation, a relay STA may be required. A relay STA refers to a device that receives a PPDU (e.g., the aforementioned HT/VHT/HE/EHT/UHR-PPDU) from a first STA (e.g., an AP STA) and relays the received PPDU to a second STA (e.g., a non-AP STA).

The relay function/operation/procedure performed by the relay STA in the present disclosure may be implemented in various ways. For example, the relay STA may receive a first PPDU from the first STA and decode a portion of the received first PPDU. For example, the relay STA can decode the PHY preamble (e.g., L-SIG, U-SIG, EHT-SIG, etc.) included in the first PPDU, and decode a part of the MAC frame (e.g., MAC header) included in the data field of the first PPDU. Through this, the relay STA can obtain the frame body of the MAC frame of the first PPDU, and can relay the frame body of the MAC frame to the second STA without performing additional decoding on the frame body of the obtained MAC frame. That is, the relay STA can encode/generate/configure the second PPDU based on the body of the MAC frame, and transmit the second PPDU to the second STA. As a result, the first PPDU and the second PPDU can include the same payload or MAC frame body. For example, the PHY preamble and/or MAC header of the first PPDU received by the relay STA may be identical to or different from the PHY preamble and/or MAC header of the second PPDU transmitted by the relay STA. For example, the relay STA may not decode the MAC frame (i.e., the frame body) other than the MAC header of the first PPDU, or may decode only a portion of it.

The relay STA of the present disclosure may be implemented in various ways.

First, the relay STA of the present disclosure may be implemented in a manner that includes a Relay-STA and a Relay-AP. That is, the relay STA may include a Relay STA that communicates with the Root AP and a Relay AP that communicates with non-APs. In this case, an upper BSS may be defined between the Root AP and the relay STA, and a lower BSS may be defined between the Relay AP and the non-AP. A relay function may be implemented between the Relay STA and the Relay AP within the relay STA.

Second, the relay STA of the present disclosure may be a terminal/device that operates as a non-AP STA (i.e., a user STA). That is, the relay STA of the present disclosure may belong to a BSS defined/configured by an AP STA without newly defining/configuring a lower BSS by itself. The AP STA may assign an ID (e.g., AID) to the relay STA in the same manner as a conventional non-AP STA (i.e., a user STA). That is, the relay STA may be identified like a typical non-AP STA (i.e., a user STA) and may additionally support the relay function/operation/procedure described above. That is, the relay STA may receive a first DL PPDU from an AP STA, obtain a MAC frame body of the first DL PPDU, and relay a second DL PPDU including the obtained MAC frame body to a neighboring non-AP STA. Additionally, the relay STA may receive a first UL PPDU from a neighboring non-AP STA, obtain the MAC frame body of the first UL PPDU, and relay a second UL PPDU including the obtained MAC frame body to the AP STA.

Thirdly, the relay STA of the present disclosure may be implemented based on multiple links. For example, the relay function/operation/procedure described above may be performed based on multiple links, such as those described in FIG. 4 of the present disclosure. That is, a specific non-AP MLD may operate as a relay STA, and in this case, the first PPDU may be received via the first link included in the non-AP MLD. The relay STA may relay the first PPDU received via the first link to another STA via the second link. For example, the first link may operate as a DL link (or UL link), and the second link may operate as a UL link (or DL link).

To facilitate relay implementation and reduce operational complexity, next-generation wireless LAN systems may consider AP-controlled relay transmission/operation.

In this disclosure, an AP-controlled relay STA is referred to as an “AP-controlled Relay STA,” or simply ACRS. The ACRS performs relay transmission for data received from an AP within a BSS. The AP may control the ACRS for relay operation. That is, based on control information received from the AP, the ACRS may transmit signals received from the AP to end-users/STAs, or transmit signals received from multiple non-AP STAs to the AP.

For example, the ACRS may be an independent relay device that only performs relay transmission. Alternatively, the ACRS may be a non-AP STA that supports relay operation.

In this disclosure, the operations performed by the ACRS may be performed not only by the ACRS, but also by various relay STAs (e.g., relay STAs not controlled by the AP).

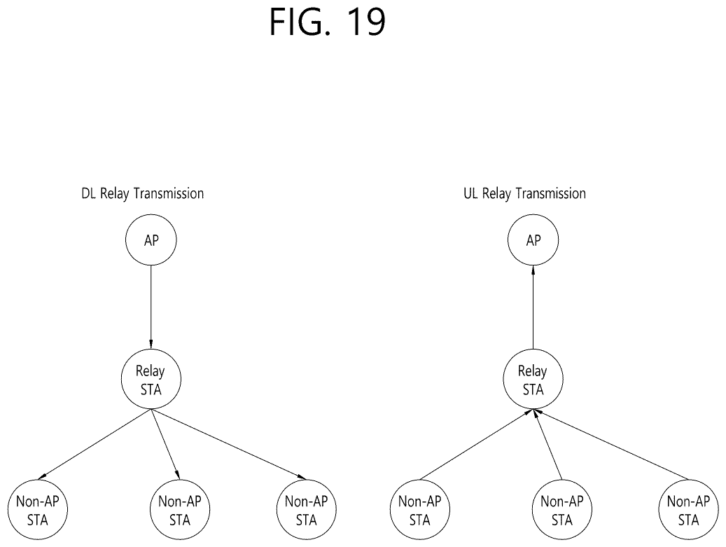

FIG. 19 illustrates an example of relay transmission/operation.

Referring to FIG. 19, in a next-generation wireless LAN system, a relay STA can transmit signals to one or more non-AP STAs located at the BSS edge or extended range, or receive signals from non-AP STAs, through relay operation. Relay operation can be performed using two links (e.g., from the AP to the relay STA and from the relay STA to the non-AP STA (DL relay transmission), or from the non-AP STA to the relay STA and from the relay STA to the AP (UL relay transmission)). Since the two links each have different channel conditions, channel information for both links may be required to efficiently perform relay operation using the two links. In addition, since the channel condition between the relay STA and the non-AP STA(s) may differ from that between the AP and the relay STA, an available channel different from the disabled subchannel information and/or punctured channel information configured by the AP may be used.

Accordingly, the present disclosure proposes a method and an apparatus for utilizing information for available channels between the relay STA and the non-AP STA(s) in order to efficiently perform relay operations. The present disclosure also proposes a procedure and corresponding signaling for estimating information for available channels and/or punctured channels between the relay STA and the non-AP STA(s) so as to efficiently perform relay transmission/operation.

In the present disclosure, a link between the relay STA and the non-AP STA may be referred to as a relay link/channel, although this is merely exemplary, and other expressions may also be used. In addition, a link between the AP and the relay STA may be referred to as an AP link/channel.

In the present disclosure, the terms “channel” and “subchannel” may be used interchangeably.

In this disclosure, the terms “channel measurement” and “channel estimation” may be used interchangeably.

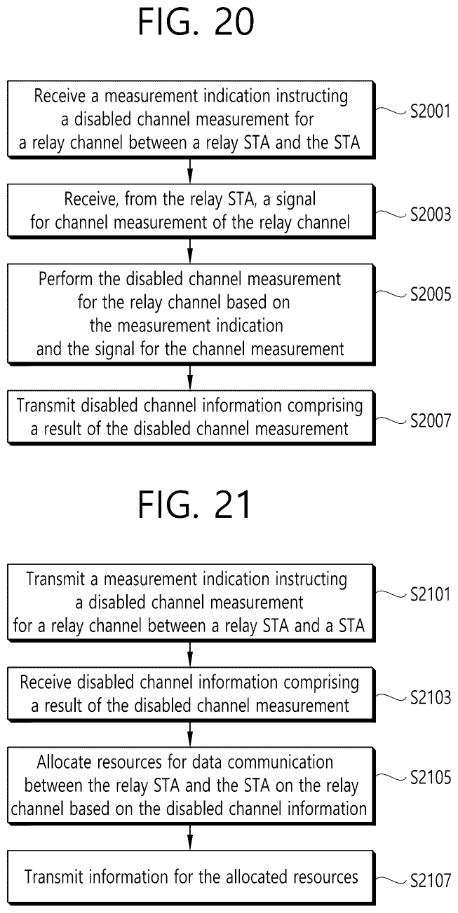

FIG. 20 illustrates an example of a method performed by a STA for processing disabled channel information according to an embodiment of the present disclosure.

Referring to FIG. 20, in step S2001, the STA may receive a measurement indication instructing a disabled channel measurement (e.g., disabled channel measurement indication) for a relay channel between a relay STA and the STA.

In step S2003, the STA may receive, from the relay STA, a signal for channel measurement (e.g., NDP) of the relay channel.

In step S2005, the STA may perform the disabled channel measurement for the relay channel based on the measurement indication and the signal for the channel measurement.

In step S2007, the STA may transmit disabled channel information comprising a result of the disabled channel measurement.

According to various embodiments, the disabled channel measurement for the relay channel may comprise identifying whether each of one or more channels in the relay channel is a disabled channel or an available channel.

According to various embodiments, the one or more channels in the relay channel may comprise at least one of a punctured channel or a disabled channel on an access point (AP) channel between the relay STA and an AP.

According to various embodiments, the one or more channels in the relay channel may exclude a punctured channel or a disabled channel on an access point (AP) channel between the relay STA and an AP.

According to various embodiments, the STA may receive information indicating at least one of a punctured channel or a disabled channel (e.g., puncturing information) on the AP channel.

According to various embodiments, the STA may receive information instructing an availability measurement for at least one of a punctured channel or a disabled channel on the AP channel. In the present disclosure, the availability measurement for channel(s) may comprise checking/identifying which of the channel(s) are available channels and which are disabled channels.

According to various embodiments, the measurement indication may comprise one bit instructing to perform the disabled channel measurement.

According to various embodiments, the STA may receive information indicating a channel size (e.g., subchannel resolution) for the disabled channel measurement. The disabled channel measurement may comprise identifying whether each of one or more channels having the channel size in the relay channel is a disabled channel or an available channel.

According to various embodiments, the disabled channel information may indicate whether each of one or more channels in the relay channel is a disabled channel or an available channel.

According to various embodiments, the disabled channel information may comprise a bitmap indicating whether each of one or more channels in the relay channel is a disabled channel or an available channel (e.g., disabled subchannel bitmap). Each bit of the bitmap may correspond to each of the one or more channels in the relay channel.

According to various embodiments, a bit set to 1 in the bitmap may indicate that a corresponding channel is a punctured channel or a disabled channel. A bit set to 0 in the bitmap may indicate that a corresponding channel is an available channel.

According to various embodiments, resources for data communication between the relay STA and the STA on the relay channel may be allocated based on the disabled channel information.

According to various embodiments, the disabled channel information for the relay channel may be different from disabled channel information for an access point (AP) channel between an AP and the relay STA.

FIG. 21 illustrates an example of a method performed by an AP for processing disabled channel information according to an embodiment of the present disclosure.

Referring to FIG. 21, in step S2101, the AP may transmit a measurement indication instructing a disabled channel measurement for a relay channel between a relay station (STA) and a STA.

In step S2103, the AP may receive disabled channel information comprising a result of the disabled channel measurement.

In step S2105, the AP may allocate resources for data communication between the relay STA and the STA on the relay channel based on the disabled channel information.

In step S2107, the AP may transmit information for the allocated resources.

Hereinafter, detailed embodiments for processing disabled channel information will be described.

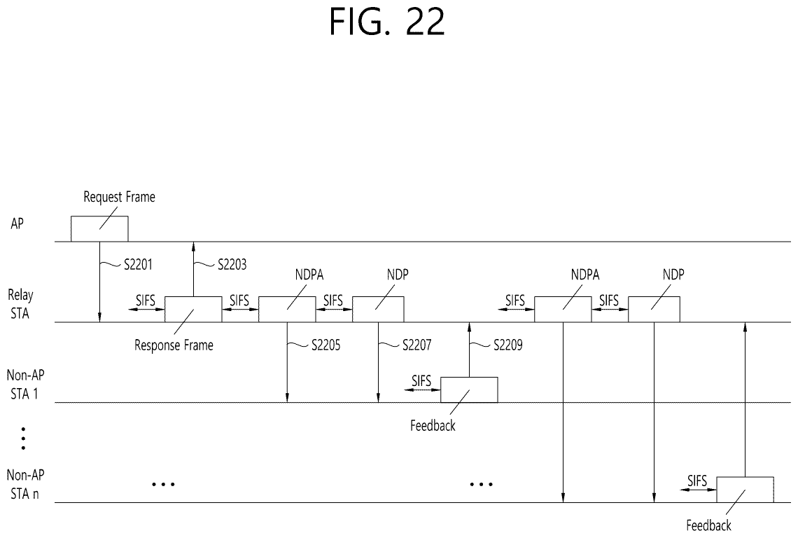

FIG. 22 illustrates a first example of a procedure for measuring available subchannels on a relay channel according to an embodiment of the present disclosure.

Referring to FIG. 22, in step S2201, an AP may transmit a request frame to a relay STA in order to request estimation of information for available channels and/or channels for the relay channel. The information for available channels and/or channels for the relay channel may be required for transmission and reception of signals for relay operation. The request frame transmitted by the AP to the relay STA may comprise at least one of the following contents:
BW: Information for the bandwidth (BW) on which the channel estimation is to be performed. The BW may indicate one of 20/40/80/160/320 MHz. For example, the BW may be equal to or greater than the BW on which the AP transmits the request frame to the relay STA.
Puncturing information: Information indicating punctured channels within the BSS (or on the AP link).
   Measurement indication for disabled (sub) channels (or disabled channel measurement indication/available channel measurement indication): Indicates that measurement of available channels (or disabled channels) within the BW is to be performed. That is, the measurement indication for disabled subchannels may instruct the relay STA to measure available/disabled channels within the BW of the relay channel. In the present disclosure, available channel measurement/disabled channel measurement comprises checking/identifying which channels among the channels within the BW of the relay channel are available channels and which are disabled channels. For example, the available/disabled channel measurement may be performed for all (sub) channels within the BW regardless of whether the (sub) channels are punctured/disabled within the BSS (or on the AP link). Alternatively, the available/disabled channel measurement may not be performed for the channels indicated as punctured by the puncturing information.

The measurement indication for disabled subchannels may consist of 1 bit. For example, when the measurement indication bit for disabled subchannels is set to 1, the indication may instruct the available/disabled channel measurement for the relay link/channel. In another example, when the measurement indication bit is set to 1, the indication may instruct the available/disabled channel measurement for all (sub) channels on the relay link/channel, including the (sub) channels punctured/disabled within the BSS (or on the AP link). In this case, when the measurement indication bit for disabled subchannels is set to 0, the indication may instruct the available/disabled channel measurement only for the (sub) channels on the relay link/channel excluding the (sub) channels punctured/disabled within the BSS (or on the AP link).
Resolution of subchannel: Indicates the size of the available subchannel. The value may indicate 20 MHz or 40 MHz. The resolution of subchannel may consist of 1 bit; for example, a value of 0 may indicate 20 MHz, and a value of 1 may indicate 40 MHz. For example, when the BW is 160 MHz or less, the bit of the resolution of subchannel may be set to 0, and when the BW is 320 MHZ, the bit of the resolution of subchannel may be set to 1.
Information for non-AP STA(s) to perform relay-channel measurement: may comprise a list of non-AP STAs (non-AP STA information list). This information may comprise an AID and/or MAC address of the non-AP STA(s) that will measure available/disabled channels of the relay channel under the control of the relay STA. For example, the non-AP STA information list may comprise information for the number of non-AP STAs and the AID/MAC address of each non-AP STA, as shown in <Table 2> below:

TABLE 2

| | |
|---|---|
| Number of non-AP STAs | AID(s) or MAC addresses |

Sounding parameters: may comprise information for sounding between the relay STA and the non-AP STA(s). For example, the sounding parameters may comprise all or part of the sounding parameters comprised in the NDPA. In step S2203, the relay STA, after receiving the request frame transmitted by the AP, may transmit a response frame to the AP. The response frame may comprise a status code indicating whether the request frame is accepted. For example, the status code may be set to “success” to indicate that the request frame is accepted, or to “deny” to indicate that the request frame is not accepted/rejected.

After transmitting the response frame, the relay STA may perform channel measurement for the channel between the relay STA and the non-AP STA(s) (i.e., the relay channel) as identified through the request frame. For instance, to check the available channels on the relay channel with the non-AP STA(s), the relay STA may perform, as shown in FIG. 22, individual processing with each non-AP STA to measure the available channels of the relay channel per non-AP STA. In this case, the available channel measurement needs to be performed for each non-AP STA.

In step S2205, the relay STA may transmit an NDPA to non-AP STA1. The NDPA may comprise an indication (e.g., a disabled channel measurement indication) instructing to perform disabled channel measurement. The disabled channel measurement indication may consist of 1 bit and may be set to 1 to instruct to perform disabled channel measurement. In addition, the NDPA may comprise a subfield indicating information for the subchannel resolution and/or size for which disabled channel measurement is to be performed. The subchannel resolution or size may be set based on the information indicated in the request frame received from the AP.

In step S2207, non-AP STA1, after receiving the NDPA from the relay STA, may receive the NDP transmitted by the relay STA and identify information (e.g., available channel information/disabled channel information) on the available/disabled channels within the BW of the relay channel. In the present disclosure, the available/disabled channel information may comprise a disabled subchannel bitmap.

In step S2209, non-AP STA1 may feed back to the relay STA the information for disabled/available channels within the BW of the relay channel as identified based on the received NDP. The information for disabled/available channels may comprise a disabled subchannel/available subchannel bitmap (e.g., a disabled subchannel bitmap). The bitmap may be configured in units of 20 MHz, and, for example, bits corresponding to 20 MHz channels outside the BW or disabled subchannels may be set to 1 Alternatively, if the information for the subchannel resolution has been received through the NDPA, the bitmap may be configured according to the indicated subchannel resolution.

After receiving, from non-AP STA1, the feedback comprising information for disabled/available channels of the corresponding relay channel, the relay STA may perform the same procedure (e.g., NDPA transmission/NDP transmission/feedback reception) for other non-AP STAs to receive the disabled channel information of the relay channel from each.

When the relay STA has completed disabled/available channel measurement for all non-AP STAs comprised in the STA list (e.g., the non-AP STA information list) comprised in the request frame received from the AP, the relay STA may feed back to the AP the disabled/available channel information for each non-AP STA. The disabled channel information fed back by the relay STA may comprise pairs of each STA ID and the corresponding disabled channel information for the relay channel.

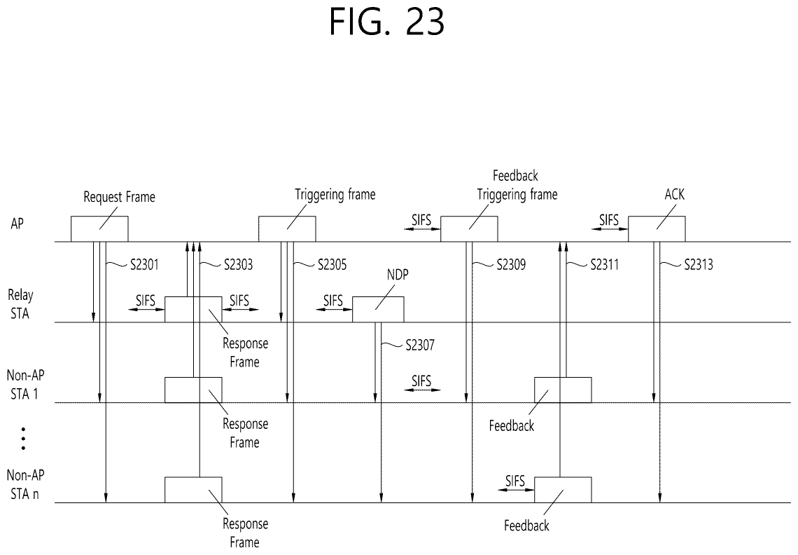

In another example, as shown in FIG. 23, the AP may transmit a request frame for available channel measurement to both the relay STA and the non-AP STA(s).

FIG. 23 illustrates a second example of a procedure for measuring available subchannels on a relay channel according to an embodiment of the present disclosure.

Referring to FIG. 23, in step S2301, the AP may transmit the request frame to the relay STA and the non-AP STA(s). The request frame may comprise information for the relay STA and the non-AP STA(s) and may further comprise at least one of the following contents:
BW: Information for the bandwidth (BW) on which channel estimation is to be performed. The BW may indicate one of 20/40/80/160/320 MHz. For example, the BW may be equal to or greater than the BW on which the AP transmits the request frame to the relay STA.
RU allocation: Information for the allocation of RU(s) for the relay STA and non-AP STA(s) that have received the request frame to transmit a response frame.
Resolution of subchannel: This field indicates the size of an available subchannel. The resolution may indicate 20 MHz or 40 MHz. The resolution of subchannel may be configured with 1 bit. For example, when the bit is set to 0, it indicates 20 MHz, and when set to 1, it indicates 40 MHz. For instance, when the bandwidth (BW) is equal to or less than 160 MHz, the bit of the resolution of subchannel may be set to 0, and when the BW is 320 MHz, it may be set to 1.
Puncturing information: This field indicates information for punctured channels within a BSS.
User list field (or user information list field): The user list field may comprise a list or combination of user fields (or user information fields). A user field for a specific non-AP STA may be identified by an AID comprised in the user field, and the AID may comprise a STA ID and/or a MAC address.

For example, the user field may comprise a request for disabled/available channel measurement and/or an instruction from the relay STA to the non-AP STA for channel measurement (e.g., a disabled channel measurement indication). The disabled channel measurement indication may instruct measurement of available/disabled channels on a channel between the relay STA and the non-AP STA (e.g., a relay channel). The disabled channel measurement indication may be configured with 1 bit. For example, the bit of the disabled channel measurement indication may be set to 1 to indicate that available/disabled channel measurement is to be performed. When the disabled channel measurement indication bit is set to 0, the non-AP STA may not perform the available/disabled channel measurement.

For example, the disabled channel measurement indication may be comprised not in the user field but in a common information field of a request frame. In this case, the disabled channel measurement indication may be commonly applied to all non-AP STAs.
Operation mode indication: The operation mode indication may indicate an operation mode (e.g., TX mode or RX mode) of each STA during relay channel measurement (e.g., measurement of available/disabled channels on a relay channel). The operation mode indication may be composed of 1 bit. For example, the operation mode indication bit may be set to 1 to indicate a TX mode and may be set to 0 to indicate an RX mode.

For instance, the operation mode may indicate whether a STA plays a transmitting or receiving role for an NDP during relay channel measurement or estimation. For example, in a user field corresponding to a relay STA, the operation mode indication bit may be set to 1 to instruct transmission of the NDP, while in a user field corresponding to a non-AP STA, the operation mode indication bit may be set to 0 to instruct reception of the NDP.
Measurement parameters: The measurement parameters may comprise information for measuring a channel state. For example, the measurement parameters may be the same as sounding parameters comprised in an (EHT) NDPA or may comprise a combination of one or more sounding parameters.

In step S2303, the non-AP STA(s) and the relay STA may transmit a response frame to the AP. The response frame may comprise a status code indicating whether the request frame is accepted. For example, the status code may be set to “success” to indicate acceptance of the request frame, or may be set to “deny” to indicate non-acceptance or rejection of the request frame.

In step S2305, after receiving the response frame, the AP may transmit a trigger frame or an announce frame to the relay STA and the non-AP STA(s) to instruct initiation or execution of relay channel measurement (e.g., measurement of available/disabled channels on the relay channel). For example, the trigger frame or announce frame may comprise information indicating the disabled channel measurement and/or the resolution of subchannel.

In step S2307, after receiving the trigger frame, the relay STA may transmit an NDP, and the non-AP STA(s) may prepare to receive the NDP transmitted by the relay STA (e.g., by listening or monitoring). The NDP transmitted by the relay STA may be based on at least one of an EHT NDP format or an HE NDP format.

In step S2309, after transmission/reception of the NDP and after a time interval corresponding to SIFS elapses, the AP may transmit a feedback request frame or trigger frame to the non-AP STA(s) to request measurement results (e.g., disabled channel information) for the relay channel. The feedback request frame/trigger frame may comprise RU allocation information for each non-AP STA for reporting feedback (e.g., disabled channel information). The feedback request frame/trigger frame may also comprise information indicating operation modes (e.g., TX mode/RX mode) of the relay STA and the non-AP STA(s) when performing relay channel measurement (e.g., measurement of available/disabled channels on the relay channel).

In step S2311, upon receiving a frame (e.g., a feedback request frame or a trigger frame) that solicits feedback reporting, a non-AP STA may transmit, to the AP, a feedback frame comprising relay channel information measured by the non-AP STA. The feedback frame/relay channel information transmitted by the non-AP STA may comprise information for disabled channels within the bandwidth of the relay channel. In this case, the disabled channel information may comprise a bitmap based on subchannel units.

In step S2313, after receiving the feedback frame(s) from the non-AP STA(s), the AP may transmit an ACK frame to the non-AP STA(s).

According to the procedure illustrated in FIG. 23, the measurement of disabled/available channels for a relay channel (e.g., disabled channel measurement/available channel measurement) may be performed together with a plurality of non-AP STAs. Accordingly, the processing time can be reduced as compared to a case in which each non-AP STA individually performs disabled/available channel measurement.

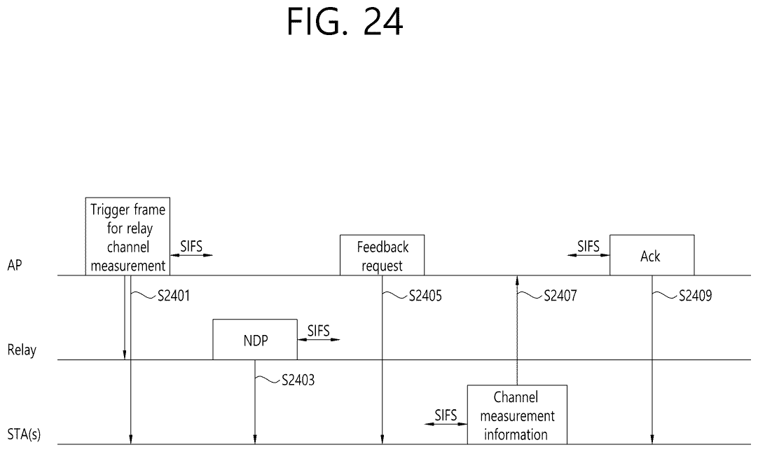

In another example, as illustrated in FIG. 24, the measurement of the relay channel (e.g., available channel/disabled channel measurement) may be indicated using a trigger frame without exchanging request and response frames.

FIG. 24 illustrates a third example of a procedure for measuring available subchannels in a relay channel according to an embodiment of the present disclosure.

Referring to FIG. 24, in step S2401, the AP may transmit, to a relay STA and non-AP STAs, a trigger frame for initiating relay channel measurement (e.g., available channel/disabled channel measurement for the relay channel). The trigger frame transmitted by the AP may comprise information for the relay STA and the non-AP STAs that perform the relay channel measurement.

For example, a user field (or user information field) of the trigger frame may comprise information for the STA (relay STA/non-AP STA). In addition, the user field/information for the STA may comprise information that indicates the operation mode of the STA (e.g., operation mode indication). The operation mode may comprise TX mode/RX mode, and the operation mode indication may indicate the operation mode of the STA. The operation mode indication may be composed of one bit. For example, the operation mode indication bit may be set to ‘1’ to indicate a TX mode, and set to ‘0’ to indicate an RX mode. The TX mode may indicate NDP transmission, and the RX mode may indicate NDP reception. For instance, in the case of a DL channel measurement) the relay STA may be set to the TX mode and the non-AP STAs may be set to the RX mode.

For example, the trigger frame may comprise an indication for disabled channel measurement indicating to identify which of the channels in the relay channel are available or disabled. Also, the trigger frame may further comprise information indicating a subchannel resolution for identifying the available/disabled channels.

The trigger frame for relay channel measurement/estimation may be defined as a new variant. For example, if the trigger type subfield of the trigger frame indicates a relay trigger frame as a variant, the trigger frame may be regarded as a relay trigger frame.

In step S2403, after receiving the trigger frame, the relay STA may transmit an NDP, and the non-AP STAs may prepare (e.g., listen/monitor) for receiving the NDP transmitted by the relay STA.

In step S2405, after transmission/reception of the NDP and elapse of a SIFS duration, the AP may transmit, to the non-AP STAs, a feedback request frame or a trigger frame to request measurement results (e.g., disabled channel information) on the relay channel. The feedback request frame/trigger frame may comprise RU allocation information for each non-AP STA to report feedback (e.g., disabled channel information).

In step S2407, upon receiving a frame (e.g., a feedback request frame/trigger frame) that solicits feedback reporting, a non-AP STA may transmit, to the AP, a feedback frame comprising relay channel information measured by the non-AP STA. The feedback frame/relay channel information transmitted by the non-AP STA may comprise disabled channel information within the bandwidth of the relay channel. In this case, the disabled channel information may comprise a bitmap based on subchannel resolution.

In step S2409, after receiving feedback frames from the non-AP STA(s), the AP may transmit an ACK frame to the non-AP STA(s).

In some implementations, disabled channel measurement/available channel measurement for the relay channel may be performed through a sounding procedure for the relay link/channel. In this case, since a separate procedure for disabled/available channel measurement of the relay channel does not need to be performed, the overall process can be simplified.

To perform disabled (sub) channel measurement/available channel measurement while conducting the sounding procedure for the relay channel, a sounding NDPA/trigger frame comprising at least one of the contents of the request frame/NDPA/trigger frame/feedback request frame described in FIGS. 22 to 24 may be transmitted to the relay STA and/or the non-AP STA(s).

Based on disabled channel measurement parameters (e.g., a disabled channel measurement indication/subchannel resolution) ncluded in the sounding NDPA/trigger frame, the non-AP STA may perform measurement (i.e., disabled/available channel measurement) of disabled subchannels during channel estimation and obtain disabled (sub) channel information. The non-AP STA may transmit, to the AP (via the relay STA), disabled channel information/channel information obtained through the relay channel measurement.

In various embodiments, the AP that has obtained information (e.g., disabled channel information/available channel information) on disabled subchannels measured by the non-AP STA(s) through the relay channel measurement procedure of the present disclosure may perform RU allocation (RA) for the relay STA to transmit a signal to the non-AP STA based on the information of the disabled subchannels. The AP may then transmit RA information corresponding to the RU allocation result to the relay STA and/or the non-AP STA(s).

The RA information may be generated based on disabled (sub) channel information/preamble puncturing information (for the relay channel) that is different from the disabled (sub) channel information/preamble puncturing information announced by the AP within the BSS. That is, the disabled (sub) channel information/preamble puncturing information used by the AP to transmit a signal to the relay STA may be different from the disabled (sub) channel information/preamble puncturing information used by the relay STA to transmit a signal to the non-AP STA(s).

For example, a (sub) channel configured as a punctured channel for signal transmission within the BSS by the AP may correspond to an available channel in the relay channel used for relay transmission. Conversely, a channel available within the BSS may be configured as an disabled (sub) channel in the relay channel.

In another example, during resource allocation (RA) for relay transmission, the AP may take into account both the disabled/punctured (sub) channels in the BSS and those in the relay channel, and may refrain from allocating resources corresponding to such channels.

The technical features of the present disclosure described above can be applied to various devices and methods. For example, the technical features of the present disclosure described above can be performed/supported by the devices of FIG. 1 and/or FIG. 13. For example, the technical features of the present disclosure described above can be applied only to a part of FIG. 1 and/or FIG. 13. For example, the technical features of the present disclosure described above can be implemented based on the processing chips 114, 124 of FIG. 1, or implemented based on the processors 111, 121 and the memories 112, 122 of FIG. 1, or implemented based on the processor 610 and the memory 620 of FIG. 13.

For example, the processor 111, the processing chip 114 of FIG. 1 and/or the processor 610 of FIG. 13 may be configured to execute instructions stored in the memory 112, 620 to implement the method performed by the STA in the present disclosure. The method comprises: receiving a measurement indication instructing a disabled channel measurement for a relay channel between a relay STA and the STA; receiving, from the relay STA, a signal for channel measurement of the relay channel; performing the disabled channel measurement for the relay channel based on the measurement indication and the signal for the channel measurement; and transmitting disabled channel information comprising a result of the disabled channel measurement.

For example, the processor 121 and/or processing chip 124 of FIG. 1 may be configured to execute instructions stored in the memory 122 to implement the method performed by the AP in the present disclosure. The method comprises: transmitting a measurement indication instructing a disabled channel measurement for a relay channel between a relay station (STA) and a STA; receiving disabled channel information comprising a result of the disabled channel measurement; allocating resources for data communication between the relay STA and the STA on the relay channel based on the disabled channel information; and transmitting information for the allocated resources.

The technical features of the present disclosure can be implemented based on a computer readable medium (CRM) (e.g., non-transitory CRM). For example, the CRM in the present disclosure may comprise at least one CRM having stored thereon a program code implementing instructions executed by at least one processor.

For example, the CRM may be the memory 112 of FIG. 1, the memory 620 of FIG. 13, and/or a separate external memory/storage medium/disk. The CRM may store instructions that implement the method performed by the STA in the present disclosure based on being executed by a processor (e.g., the processor 111, the processing chip 114 of FIG. 1, and/or the processor 610 of FIG. 13). The method comprises: receiving a measurement indication instructing a disabled channel measurement for a relay channel between a relay STA and the STA; receiving, from the relay STA, a signal for channel measurement of the relay channel; performing the disabled channel measurement for the relay channel based on the measurement indication and the signal for the channel measurement; and transmitting disabled channel information comprising a result of the disabled channel measurement.

For example, the CRM may be the memory 122 of FIG. 1 and/or a separate external memory/storage medium/disk. The CRM may store instructions that implement the method performed by the AP in the present disclosure based on being executed by a processor (e.g., the processor 121 and/or the processing chip 124 of FIG. 1). The method comprises: transmitting a measurement indication instructing a disabled channel measurement for a relay channel between a relay station (STA) and a STA; receiving disabled channel information comprising a result of the disabled channel measurement; allocating resources for data communication between the relay STA and the STA on the relay channel based on the disabled channel information; and transmitting information for the allocated resources.

The foregoing technical features of this disclosure are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The present disclosure may have various advantageous effects.

For example, during relay transmission, the AP may allocate a resource unit (RU) suitable for the relay transmission by using information for available channels and/or disabled channels between the relay STA and the non-AP STA. The relay transmission may then be performed based on the allocated RU, thereby improving the efficiency and throughput of the relay transmission.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus, and technical features in method claim(s) and apparatus claim(s) can be combined to be implemented or performed in a method.

1. A method comprising:
receiving a measurement indication instructing a disabled channel measurement for a relay channel between a relay station (STA) and a STA;
receiving, from the relay STA, a signal for channel measurement of the relay channel;
performing the disabled channel measurement for the relay channel based on the measurement indication and the signal for the channel measurement; and
transmitting disabled channel information comprising a result of the disabled channel measurement.

2. The method of claim 1, wherein the disabled channel measurement for the relay channel comprises identifying whether each of one or more channels in the relay channel is a disabled channel or an available channel.

3. The method of claim 2, wherein the one or more channels in the relay channel comprise at least one of a punctured channel or a disabled channel on an access point (AP) channel between the relay STA and an AP.

4. The method of claim 2, wherein the one or more channels in the relay channel exclude a punctured channel or a disabled channel on an access point (AP) channel between the relay STA and an AP.

5. The method of claim 4, further comprising receiving information instructing an availability measurement for at least one of a punctured channel or a disabled channel on the AP channel.

6. The method of claim 1, wherein the measurement indication comprises one bit instructing to perform the disabled channel measurement.

7. The method of claim 1, further comprising receiving information indicating a channel size for the disabled channel measurement,
wherein the disabled channel measurement comprises identifying whether each of one or more channels having the channel size in the relay channel is a disabled channel or an available channel.

8. The method of claim 1, wherein the disabled channel information indicates whether each of one or more channels in the relay channel is a disabled channel or an available channel.

9. The method of claim 1, wherein the disabled channel information comprises a bitmap indicating whether each of one or more channels in the relay channel is a disabled channel or an available channel, and
wherein each bit of the bitmap corresponds to each of the one or more channels in the relay channel.

10. The method of claim 9, wherein a bit set to 1 in the bitmap indicates that a corresponding channel is a punctured channel or a disabled channel, and
wherein a bit set to 0 in the bitmap indicates that a corresponding channel is an available channel.

11. The method of claim 1, wherein resources for data communication between the relay STA and the STA on the relay channel are allocated based on the disabled channel information.

12. The method of claim 1, wherein the disabled channel information for the relay channel is different from disabled channel information for an access point (AP) channel between an AP and the relay STA.

13. A station (STA) comprising:
a transceiver;
a memory; and
at least one processor operatively coupled to the transceiver and the memory,
wherein the memory stores instructions that, based on being executed by the at least one processor, perform operations comprising:
receiving a measurement indication instructing a disabled channel measurement for a relay channel between a relay STA and the STA;
receiving, from the relay STA, a signal for channel measurement of the relay channel;
performing the disabled channel measurement for the relay channel based on the measurement indication and the signal for the channel measurement; and
transmitting disabled channel information comprising a result of the disabled channel measurement.

14. (canceled)

15. (canceled)

16. (canceled)

17. An access point (AP) comprising:
a transceiver;
a memory; and
at least one processor operatively coupled to the transceiver and the memory,
wherein the memory stores instructions that, based on being executed by the at least one processor, perform operations comprising:
transmitting a measurement indication instructing a disabled channel measurement for a relay channel between a relay station (STA) and a STA;
receiving disabled channel information comprising a result of the disabled channel measurement;
allocating resources for data communication between the relay STA and the STA on the relay channel based on the disabled channel information; and
transmitting information for the allocated resources.

18. The AP of claim 17, wherein the disabled channel information comprises a bitmap indicating whether each of one or more channels in the relay channel is a disabled channel or an available channel, and
wherein each bit of the bitmap corresponds to each of the one or more channels in the relay channel.

19. The AP of claim 18, wherein a bit set to 1 in the bitmap indicates that a corresponding channel is a punctured channel or a disabled channel, and
wherein a bit set to 0 in the bitmap indicates that a corresponding channel is an available channel.

20. The AP of claim 17, wherein the disabled channel information for the relay channel is different from disabled channel information for an AP channel between the AP and the relay STA.
